(19) United States
(12) Patent Application Publication
(10) Pub. No.: US 2023/0416521 A1
(43) Pub. Date: Dec. 28, 2023

(54) THERMOSETTING EPOXY RESIN COMPOSITION, MOLDED ARTICLE FROM THERMOSETTING EPOXY RESIN, MOLDING MATERIAL FOR FIBER-REINFORCED COMPOSITE MATERIAL, FIBER-REINFORCED COMPOSITE MATERIAL, AND METHOD FOR PRODUCING FIBER-REINFORCED COMPOSITE MATERIAL

(71) Applicant: TORAY INDUSTRIES, INC., Tokyo (JP)

(72) Inventors: Shinya HAYASHI, Nagoya-shi (JP); Ko MATSUKAWA, Nagoya-shi (JP); Nobuyuki TOMIOKA, Nagoya-shi (JP)

(73) Assignee: TORAY INDUSTRIES, INC., Tokyo (JP)

(21) Appl. No.: 18/039,754

(22) PCT Filed: Dec. 2, 2021
(86) PCT No.: PCT/JP2021/044244

§ 371 Date: Jun. 1, 2023

(30) Foreign Application Priority Data
Dec. 8, 2020 (JP) 2020-203126
Jul. 27, 2021 (JP) 2021-122175

(51) Int. Cl. C08L 63/00; B29C 70/22; C08G 59/40; B01J 31/02

(52) U.S. Cl. CPC C08L 63/00; B29C 70/22; C08G 59/4028; B01J 31/0235; B29K 2063/00

(57) ABSTRACT

The purpose of the present invention is to provide a thermosetting epoxy resin composition with ability to allow cured products to have excellent toughness and to stably maintain high stiffness. In order to achieve the purpose, the thermosetting epoxy resin composition of the present invention includes the following components [a], [b], [c], and [d], wherein the stoichiometric ratio [b]/[a] of the component [b] to the component [a] is in the range from 0.7 to 2.0 thermosetting epoxy resin composition:
[a] an epoxy resin;
[b] an isocyanate curing agent;
[c] an elastomeric toughening agent;
[d] an oxazolidone cyclization catalyst.

### TECHNICAL FIELD

The present invention relates to a thermosetting epoxy resin composition, a thermosetting epoxy resin-based molded article, a molding material for fiber-reinforced composite material, a fiber-reinforced composite material, and a method of producing a fiber-reinforced composite material.

### BACKGROUND ART

Thermosetting resins are liquid and easy to handle before curing and are cured by heat to form cross-linked structures and become insoluble and infusible resins that exhibit excellent heat resistance and chemical resistance and are therefore used in various fields. Among those, epoxy resins have become widely used in painting materials, electrical and electronic materials, civil engineering and construction materials, adhesives, fiber-reinforced composite materials, and the like because epoxy resins will not outgas while curing, shrink slightly when curing, and exhibit excellent adhesiveness, stiffness, toughness, and the like after curing.

Epoxy resins are classified into several types depending on a curing agent used, and commonly used epoxy resins include the following resins: amine-cured epoxy resins, which are most commonly used type of epoxy resins and exhibit high mechanical properties; phenol-cured epoxy resins, which are often used in solid or powder form and have a long pot life and high wet heat resistance; acid anhydride-cured epoxy resins, which have a low viscosity and a long pot life; and the like. However, any of the curing agent-based systems have required a high cross-linking density to have sufficient heat resistance and consequently failed to have sufficient toughness. Patent Literature 1 indicates that addition of a large amount of core shell rubber particles to a specific amine-cured epoxy will provide a cured product with high toughness, but the cured product had a problem of reduced stiffness in a high temperature range.

To deal with the problem, epoxy resins for which an isocyanate is used as a curing agent are proposed, and the epoxy resins have been indicated to have both high heat resistance and excellent mechanical properties. Patent Literature 2 indicates that a cured product with excellent tensile strength and elongation at high temperatures can be provided by using a catalyst selected from DBU (registered trademark) or derivatives thereof for the reaction between such an epoxy and an isocyanate. Patent Literature 3 indicates an example of using a catalyst selected from certain imidazolium salts for the reaction between such an epoxy and an isocyanate and suggests possible addition of a toughening agent(s).

### CITATION LIST

### Patent Literature

Patent Literature 1: JP 2009-280669 A
Patent Literature 2: WO 2014/184082
Patent Literature 3: WO 2016/102358

### SUMMARY OF INVENTION

### Technical Problem

The thermosetting epoxy resin compositions described in Patent Literature 1 provided cured products with improved toughness, but the stiffness of the cured products greatly varied depending on the amount of the core shell rubber particles and was changed to an unacceptable degree as the temperature changed from low to high temperature.

The thermosetting epoxy resin compositions described in Patent Literature 2 generated large amounts of urethane and/or isocyanurate structures in cured products and therefore still had a poor balance between heat resistance and toughness.

The thermosetting epoxy resin compositions described in Patent Literature 3 generated large amounts of urethane and/or isocyanurate structures in cured products and therefore still had a poor balance between heat resistance and toughness, and the cured products failed to save reduction in stiffness even though a toughening agent was contained in the cured products.

An object of the present invention is to provide a thermosetting epoxy resin composition with ability to allow cured products to have excellent toughness and to stably maintain high stiffness, in which drawbacks related to the prior arts are improved.

### Solution to Problem

To achieve the above objects, the present invention includes a thermosetting epoxy resin composition comprising the following components [a], [b], [c], and [d], wherein the stoichiometric ratio [b]/[a] of the component [b] to the component [a] is in the range from 0.7 to 2.0:
[a] an epoxy resin;
[b] an isocyanate curing agent;
[c] an elastomeric toughening agent;
[d] an oxazolidone cyclization catalyst.

Additionally, the first aspect of a thermosetting epoxy resin-based molded article according to the present invention is prepared by thermally curing the thermosetting epoxy resin composition of the invention.

The second aspect of the thermosetting epoxy resin-based molded article of the invention comprises microdomains with an absorbance ratio Da/(Da+db) ranging from 0.55 to 1 and a glass transition temperature Tg′ of −30° C. or lower
(the absorbance ratio is determined by calculating an absorbance ratio Da/(Da+db) from the absorbance Da of the C═O double bond in the carboxyl group of an oxazolidone ring and the absorbance db of the C═O double bond in the carboxyl group of an isocyanurate ring measured by the FT-IR/ATR method).

The third aspect of the thermosetting epoxy resin-based molded article of the invention in which the relationship between the glass transition temperature Tg and the rubbery modulus Gr expressed by the formula 1 is satisfied, and which comprises microdomains with a glass transition temperature Tg′ of −30° C. or lower:

Tg≥10×Gr+130 (Formula 1).

Additionally, the molding material for fiber-reinforced composite material according to the present invention comprises the thermosetting epoxy resin composition of the invention and a reinforcing fiber.

Additionally, the first aspect of the fiber-reinforced composite material according to the present invention is prepared by thermally curing the molding material for fiber-reinforced composite material according to the present invention.

The second aspect of the fiber-reinforced composite material according to the present invention comprises the thermosetting epoxy resin-based molded article of the invention and a reinforcing fiber.

The first aspect of the method of the invention for producing a fiber-reinforced composite material comprises impregnating reinforcing fibers with the thermosetting epoxy resin of the invention and then curing the thermosetting epoxy resin by heat.

The second aspect of the method of the invention for producing a fiber-reinforced composite material comprises placing a woven fabric composed primarily of reinforcing fibers into a mold, impregnating the woven fabric with the thermosetting epoxy resin composition of the invention injected into the mold, and then curing the thermosetting epoxy resin composition by heat.

### Advantageous Effects of Invention

The present invention can provide a thermosetting epoxy resin composition with ability to allow cured products to have excellent toughness and to stably maintain high stiffness. In the present invention, the “ability to allow cured products to have excellent toughness and to stably maintain high stiffness” is determined based on the formula 2 below, which evaluates the balance between toughness and stiffness retention.

### DESCRIPTION OF EMBODIMENTS

A thermosetting epoxy resin composition (hereinafter sometimes simply referred to as “epoxy resin composition”) according to the present invention and a molded article from the epoxy resin composition will be described below in details.

The thermosetting epoxy resin composition of the invention comprises the following components [a], [b], [c], and [d], wherein the stoichiometric ratio [b]/[a] of the component [b] to the component [a] is in the range from 0.7 to 2.0:
[a] an epoxy resin;
[b] an isocyanate curing agent;
[c] an elastomeric toughening agent;
[d] an oxazolidone cyclization catalyst.

In the present invention, the component [a] is an epoxy resin. The epoxy resin is not limited to a specific epoxy resin as long as the epoxy resin is a compound containing an oxirane group in the molecule, but a compound containing at least two oxirane groups in the molecule is preferred. The presence of such a structure more likely allows the molded article to exhibit the heat resistance and the toughness. Among others, an epoxy resin having a number average molecular weight in the range from 200 to 800 and containing aromatic groups in the backbone is suitable for use as the component [a] because such an epoxy resin provides an epoxy resin composition with low viscosity and excellent impregnating property into reinforcing fibers and because a fiber-reinforced composite material from the epoxy resin composition has excellent mechanical properties, such as heat resistance and elastic modulus. The number average molecular weight of an epoxy resin is determined by GPC (Gel Permeation Chromatography) using, for example, a polystyrene standard sample. For an epoxy resin with a known epoxy equivalent weight, a value calculated from the product of the epoxy equivalent weight and the number of epoxy functional groups can be used.

Epoxy resins used in the present invention are bisphenol type epoxy resins, amine-type epoxy resins, and the like.

The bisphenol type epoxy resins used in the present invention include, for example, bisphenol A-type epoxy resins, bisphenol F-type epoxy resins, bisphenol AD-type epoxy resins, and halogenated, alkylated, and hydrogenated derivatives thereof. Among others, bisphenol F-type epoxy resins are suitable for use because this type of epoxy resins are well-balanced with respect to high elastic modulus and high toughness. Specific examples of the epoxy resins are described below.

As bisphenol A-type epoxy resins, commercial products, such as “jER (registered trademark)” 825, “jER (registered trademark)” 827, “jER (registered trademark)” 828 (all manufactured by Mitsubishi Chemical Co.), “EPICLON (registered trademark)” 840, “EPICLON (registered trademark)” 850 (all manufactured by DIC Co.), “Epotohto (registered trademark)” YD-128, “Epotohto (registered trademark)” YD-8125, “Epotohto (registered trademark)” YD-825GS (all manufactured by Nippon Steel Chemical & Material Co., Ltd.), “DER (registered trademark)” 331, and “DER (registered trademark)” 332 (all manufactured by The Dow Chemical Co.), can be used.

As bisphenol F-type epoxy resins, commercial products, such as “jER (registered trademark)” 806, “jER (registered trademark)” 807, “jER (registered trademark)” 4004P (all manufactured by Mitsubishi Chemical Co.), “EPICLON (registered trademark)” 830 (manufactured by DIC Co.), “Epotohto (registered trademark)” YD-170, “Epotohto (registered trademark)” YDF-8170C, and “Epotohto (registered trademark)” YDF-870GS (all manufactured by Nippon Steel Chemical & Material Co., Ltd.), can be used.

As bisphenol AD-type epoxy resins, commercial products, such as EPOX-MK R710, and EPOX-MK R1710 (all manufactured by Printec Co.), can be used.

The amine-type epoxy resins used in the present invention include, for example, tetraglycidyl diaminodiphenylmethane, tetraglycidyl diaminodiphenyl sulfone, triglycidyl aminophenol, triglycidyl aminocresol, diglycidyl aniline, diglycidyl toluidine, tetraglycidyl xylylenediamine, and halogenated, alkylated, and hydrogenated derivatives thereof. Specific examples of the epoxy resins are described below.

Commercial tetraglycidyl diaminodiphenylmethane products include, for example, “SUMI-EPOXY (registered trademark)” ELM434 (manufactured by Sumitomo Chemical Co., Ltd.), YH434L (manufactured by Nippon Steel Chemical & Material Co., Ltd.), “jER (registered trademark)” 604 (manufactured by Mitsubishi Chemical Co.), “ARALDITE (registered trademark)” MY720, and “ARALDITE (registered trademark)” MY721 (all manufactured by Huntsman Advanced Materials).

Commercial tetraglycidyl diaminodiphenyl sulfone products include, for example, TG3DAS (manufactured by Mitsui Fine Chemicals, Inc.).

Commercial triglycidyl aminophenol or triglycidyl aminocresol products include, for example, “SUMI-EPOXY (registered trademark)” ELM100, “SUMI-EPOXY (registered trademark)” ELM120 (all manufactured by Sumitomo Chemical Co., Ltd.), “ARALDITE (registered trademark)” MY0500, “ARALDITE (registered trademark)” MY0510, “ARALDITE (registered trademark)” MY0600 (all manufactured by Huntsman Advanced Materials), and “jER (registered trademark)” 630 (manufactured by Mitsubishi Chemical Co.).

Preferably, an amine-type epoxy resin is used in combination with a bisphenol type epoxy resin for improving the balance between the high elastic modulus, the high heat resistance, and the high toughness.

The component [a] in the present invention is preferably an epoxy resin containing less hydroxyl groups. Epoxy resins, including subcomponents thereof, often contain a small amount of hydroxyl groups, and the urethane-forming reaction occurring between the hydroxyl groups and an isocyanate curing agent may result in a decreased pot life or can provide a molded article with low heat resistance and/or poor toughness. The amount of hydroxyl groups contained in the component [a] is desired to be preferably not more than 0.50 mmol/g, more preferably not more than 0.30 mmol/g, still more preferably not more than 0.24 mmol/g, still more preferably not more than 0.16 mmol/g, still more preferably not more than 0.10 mmol/g, and still more preferably not more than 0.07 mmol/g. In cases where the amount of the hydroxyl groups is more than 0.50 mmol/g, the resulting epoxy resin composition may have high viscosity and a short pot life and can reduce the heat resistance and toughness of the molded article.

The amount of hydroxyl groups contained in the component [a] can be measured using, for example, the acetyl chloride-pyridine method in accordance with JIS K 0070 (1992). Specifically, in the acetyl chloride-pyridine method, the amount of hydroxyl groups is measured by dissolving a sample in pyridine, adding an acetyl chloride-toluene solution to the solution, heating the resulting mixture, adding water to the mixture for cooling, again boiling the resulting mixture to hydrolyze an excess amount of acetyl chloride, and then titrating the generated acetic acid with a potassium hydroxide-ethanol solution.

In the present invention, the component [b] is an isocyanate curing agent. The isocyanate curing agent is not limited to a specific isocyanate curing agent as long as the isocyanate curing agent is a compound containing an isocyanate group in the molecule, but a compound containing at least two isocyanate groups in the molecule is preferred. During thermal curing, the isocyanate group(s) is reacted with the oxirane group(s) of the component [a] to form a rigid structure(s) of oxazolidone ring, which causes a molded article to exhibit high heat resistance and excellent toughness.

As the isocyanate curing agent, an aromatic isocyanate, an aliphatic isocyanate, an alicyclic isocyanate, and the like can be used. Among others, an aromatic isocyanate containing an aromatic group(s) in the backbone of the molecule has high curing reactivity and exhibits excellent heat resistance and is therefore suitable for use.

Examples of the isocyanate curing agent that is suitable for use in the present invention include aliphatic isocyanates, such as methylene diisocyanate, ethylene diisocyanate, propylene diisocyanate, trimethylene diisocyanate, dodecamethylene diisocyanate, hexamethylene diisocyanate, tetramethylene diisocyanate, pentamethylene diisocyanate, propylene-1,2-diisocyanate, 2,3-dimethyltetramethylene diisocyanate, butylene-1,2-diisocyanate, butylene-1,3-diisocyanate, 1,4-diisocyanate hexane, cyclopentene-1,3-diisocyanate, isophorone diisocyanate, 1,2,3,4-tetraisocyanate butane, butane-1,2,3-triisocyanate, and α,α,α′,α′-tetramethylxylylene diisocyanate; aromatic isocyanates, such as p-phenylene diisocyanate, 1-methylphenylene-2,4-diisocyanate, naphthalene-1,4-diisocyanate, tolylene diisocyanate, diphenyl-4,4-diisocyanate, benzene-1,2,4-triisocyanate, xylylene diisocyanate, diphenylmethane diisocyanate (MDI), diphenylpropane diisocyanate, tetramethylene xylene diisocyanate, and polymethylene polyphenyl isocyanate; alicyclic isocyanates, such as cyclohexane diisocyanate, methylcyclohexane diisocyanate, trimethylhexamethylene diisocyanate, isophorone diisocyanate, lysine diisocyanate, methylene-bis(4-cyclohexylisocyanate), and isopropylidene-dicyclohexyl diisocyanate. These isocyanate curing agents may be used singly or in combination of two or more.

Commercial aliphatic isocyanate products include, for example, HDI (manufactured by Tosoh Co.), “DURANATE (registered trademark)” D101, and “DURANATE (registered trademark)” D201 (all manufactured by Asahi Kasei Co.).

Commercial aromatic isocyanate products include, for example, “Lupranate (registered trademark)” MS, “Lupranate (registered trademark)” MI, “Lupranate (registered trademark)” M20S, “Lupranate (registered trademark)” M11S, “Lupranate (registered trademark)” M5S, “Lupranate (registered trademark)” T-80, “Lupranate (registered trademark)” MM-103, “Lupranate (registered trademark)” MM-102, “Lupranate (registered trademark)” MM-301 (all manufactured by BASF INOAC Polyurethanes Ltd.), “Millionate (registered trademark)” MT, “Millionate (registered trademark)” MT-F, “Millionate (registered trademark)” MT-NBP, “Millionate (registered trademark)” NM, “Millionate (registered trademark)” MR-100, “Millionate (registered trademark)” MR-200, “Millionate (registered trademark)” MR-400, “Coronate (registered trademark)” T-80, “Coronate (registered trademark)” T-65, “Coronate (registered trademark)” T-100 (all manufactured by Tosoh Co.), “COSMONATE (registered trademark)” PH, “COSMONATE (registered trademark)” M-50, and “COSMONATE (registered trademark)” T-80 (all manufactured by Mitsui Chemicals, Inc.).

Commercial alicyclic isocyanate products include, for example, “TAKENATE (registered trademark)” 600 (manufactured by Mitsui Chemicals, Inc.) and “FORTIMO (registered trademark)” 1,4-H6XDI (manufactured by Mitsui Chemicals, Inc.).

A product of a preliminary reaction between the epoxy resin and the isocyanate curing agent or between parts thereof may be blended in the composition. This method may be effective in viscosity control or storage stability enhancement.

In the thermosetting epoxy resin composition of the invention, the stoichiometric ratio [b]/[a] of the component [b] to the component [a] is in the range from 0.7 to 2.0. The stoichiometric ratio is the ratio of mole numbers of isocyanate groups contained in the component [b] to oxirane groups contained in the component [a] and is also expressed as H/E. The H/E is preferably in the range from 0.9 to 1.8 and is more preferably in the range from 1.1 to 1.6. In cases where the H/E is not less than 0.7, such an H/E ratio is preferred because the heat resistance and the toughness are increased. On the other hand, in cases where the H/E is not more than 2.0, such an H/E ratio is preferred because the heat resistance and the toughness are increased.

In the present invention, the component [c] is an elastomeric toughening agent. The elastomeric toughening agent is an additive that functions to increase the toughness of a molded article and contains an elastomeric structure in the chemical structure thereof. Examples of the elastomeric toughening agent include crosslinked rubber particles, such as core shell rubber particles; thermoplastic elastomers, such as block copolymers; terminal reactive rubbers, such as carboxyl-terminated butadiene-nitrile rubber (CTBN); and rubber-modified epoxy, such as CTBN-modified epoxy. Among those, at least one elastomeric toughening agent selected from the group consisting of a block copolymer and a core shell rubber particle is preferred as the component [c] because such a toughening agent allows for easy control of the structure and shape of a formed domain and has an effect to increase the toughness as well as to reduce side effects, such as reduction in stiffness.

In the present invention, the content of the component [c] in total is preferably not less than 0.2% by mass and not more than 8% by mass, more preferably not less than 0.2% by mass and not more than 4% by mass, still more preferably not less than 0.2% by mass and not more than 2% by mass, relative to the total amount of the epoxy resin composition, which is taken as 100% by mass. In cases where the content of the component [c] is not less than 0.2% by mass, the effect to increase the toughness becomes easily achievable. On the other hand, in cases where the content of the component [c] is not more than 8% by mass, the change in stiffness depending on a temperature environment used becomes easily reduced, as well as the stiffness at normal temperatures is increased.

In the present invention, the component [d] is an oxazolidone cyclization catalyst. The oxazolidone cyclization catalyst is a curing catalyst that preferentially promotes the oxazolidone cyclization reaction of the oxirane group of the component [a] with the isocyanate group of the component [b]. The presence of the catalyst allows the oxazolidone cyclization reaction to proceed predominantly during a thermal curing process, which results in providing a molded article with high heat resistance and excellent toughness.

The component [d] used in the present invention is not limited to a specific catalyst as long as the compound exhibits the function described above, but the compound is preferably an acid-base complex and is more preferably at least one catalyst selected from the group consisting of a Broensted acid-base complex and an onium halide salt. One or two or more of the catalysts may be contained.

In the present invention, the Broensted acid-base complex is a complex composed of a Broensted acid and a Broensted base.

In the present invention, the Broensted base is a base that can accept a proton in a neutralization reaction with an acid. Examples of the Broensted base include 1,8-diazabicyclo[5.4.0]undec-7-ene, 1,5-diazabicyclo[4.3.0]-5-nonene, 7-methyl-1,5,7-triazabicyclo[4.4.0]dec-5-ene, and 1,5,7-triazabicyclo[4.4.0]dec-5-ene.

In the present invention, the Broensted acid is an acid that can donate a proton in a neutralization reaction with a base. As the Broensted acid, for example, a carboxylic acid, a sulfonic acid, or a hydrogen halides is suitable for use.

Examples of the carboxylic acid include formic acid, acetic acid, nitric acid, benzoic acid, phthalic acid, maleic acid, fumaric acid, malonic acid, tartaric acid, citric acid, lactic acid, succinic acid, monochloroacetic acid, dichloroacetic acid, trichloroacetic acid, trifluoroacetic acid, nitroacetic acid, and triphenylacetic acid.

Examples of the sulfonic acid include methanesulfonic acid, ethanesulfonic acid, benzenesulfonic acid, p-toluenesulfonic acid, and trifluoromethanesulfonic acid.

Examples of the hydrogen halide include hydrogen chloride, hydrogen bromide, and hydrogen iodide.

In the present invention, the onium halide complex is an onium complex with a halide ion, which is a counter anion. The onium complex is not limited to a specific onium complex but is preferably a quaternary ammonium complex or a quaternary phosphonium complex.

Examples of the quaternary ammonium halide include trimethyl(octadecyl)ammonium chloride, trimethyl(octadecyl)ammonium bromide, benzyltrimethylammonium chloride, benzyltrimethylammonium bromide, tetrabutylammonium chloride, tetrabutylammonium bromide, (2-methoxyethoxymethyl)triethylammonium chloride, (2-methoxyethoxymethyl)triethylammonium bromide, (2-acetoxyethyl)trimethylammonium chloride, (2-acetoxyethyl)trimethylammonium bromide, (2-hydroxyethyl)trimethylammonium chloride, (2-hydroxyethyl)trimethylammonium bromide, bis(polyoxyethylene)dimethylammonium chloride, bis(polyoxyethylene)dimethylammonium bromide, 1-hexadecylpyridinium chloride, and 1-hexadecylpyridinium bromide.

Examples of the quaternary phosphonium halide include trimethyl(octadecyl)phosphonium chloride, trimethyl(octadecyl)phosphonium bromide, benzyltrimethylphosphonium chloride, benzyltrimethylphosphonium bromide, tetrabutylphosphonium chloride, tetrabutylphosphonium bromide, (2-methoxyethoxymethyl)triethylphosphonium chloride, (2-methoxyethoxymethyl)triethylphosphonium bromide, (2-acetoxyethyl)trimethylphosphonium chloride, (2-acetoxyethyl)trimethylphosphonium bromide, (2-hydroxyethyl)trimethylphosphonium chloride, (2-hydroxyethyl)trimethylphosphonium bromide, bis(polyoxyethylene)dimethylphosphonium chloride, bis(polyoxyethylene)dimethylphosphonium bromide, tetraphenylphosphonium bromide, acetonyltriphenylphosphonium chloride, (4-carboxybutyl)triphenylphosphonium bromide, (4-carboxypropyl)triphenylphosphonium bromide, (2,4-dichlorobenzyl)triphenylphosphonium chloride, 2-dimethylaminoethyltriphenylphosphonium bromide, ethoxycarbonylmethyl(triphenyl)phosphonium bromide, (formylmethyl)triphenylphosphonium chloride, (N-methylanilino)triphenylphosphonium iodide, and phenacyltriphenylphosphonium bromide.

The content of the component [d] in total is preferably not less than 0.1 part by mass and not more than 10 parts by mass, more preferably not less than 0.2 parts by mass and not more than 5 parts by mass, still more preferably not less than 0.5 part by mass and not more than 3 parts by mass, relative to 100 parts by mass of the component [a] in total. In cases where the content of the component [d] is less than 0.1 part by mass, the fast curability of the epoxy resin composition at low temperatures may be insufficient. On the other hand, in cases where the content of the component [d] is less than 10 parts by mass, the pot life of the epoxy resin composition may not be enough long, and the heat resistance and toughness of a molded article may be insufficient.

Preferably, the component [d] is a catalyst that can be dissolved in the epoxy resin to achieve uniform catalysis during curing process. By the “catalyst that can be dissolved in the epoxy resin” is meant that the catalyst and the epoxy resin of the component [a] are homogeneously mixed with each other when 1 part of the catalyst is added to 100 parts of the component [a] and the resulting mixture is heated to room temperature or a temperature close to the melting point of the catalyst and then stirred for 30 minutes and then left to stand at room temperature for 1 hour. Whether or not the components are homogeneously mixed is determined using, for example, phase contrast microscope based on the presence or absence of the catalyst remaining insoluble.

Preferably, the thermosetting epoxy resin composition of the invention further comprises the component [e] and satisfies the following (1):
[e] a hydroxyl group capping agent;
(1) the peak temperature Te of the exothermic reaction between the component [e] and a hydroxyl group is 15° C. or more lower than the peak temperature Tb of the exothermic reaction between the component [b] and a hydroxyl group.

Te is the peak temperature of the exothermic curve obtained by differential scanning calorimetry performed at a rate of temperature increase of 10° C./min on a mixture of 1-phenoxy-2-propanol and the component [e] in a mass ratio of 10:1. Tb is the peak temperature of the exothermic curve obtained by differential scanning calorimetry performed at a rate of temperature increase of 10° C./min on a mixture of 1-phenoxy-2-propanol and the component [b] in a mass ratio of 10:1.

The component [e] is a hydroxyl group capping agent. The hydroxyl group capping agent is a compound that can react with hydroxyl group to cap the hydroxyl group, that is, a compound that contains a protective functional group in the molecule. The hydroxyl group capping agent is a compound distinct from the component [b] in terms of chemical structure. The addition of the hydroxyl group capping agent results in capping of hydroxyl groups present in the thermosetting epoxy resin composition, particularly a small amount of hydroxyl groups that the epoxy resin of the component [a] often contains. The capping of hydroxyl groups disturbs the urethane-forming reaction between the isocyanate curing agent of the component [b], which is added separately, and the hydroxyl groups, and allows for preferential consumption of the hydroxyl groups in the curing reaction with the epoxy. Consequently, the pot life of the epoxy resin composition is increased without compromising the fast curability at low temperatures. Additionally, a molded article which absorbs only a small amount of water even in wet heat environments and is resistant to hydrolysis and has high wet heat resistance can be produced because a urethane structure is unlikely to be formed in the molded article. Furthermore, the preferential formation of a rigid structure of oxazolidone ring, together with the suppression of the side reaction, causes the molded article to have higher toughness.

In the present invention, the peak temperature Te of the exothermic reaction between the component [e] and a hydroxyl group is 15° C. or more lower, preferably 30° C. or more lower, more preferably 45° C. or more lower, than the peak temperature Tb of the exothermic reaction between the component [b] and a hydroxyl group. This causes hydroxyl groups present in the thermosetting epoxy resin composition to preferentially react with the hydroxyl group capping agent over the isocyanate curing agent and to be capped by the hydroxyl group capping agent. As a result, the isocyanate curing agent is consumed for the epoxy curing reaction but not for the urethane-forming reaction with hydroxyl groups, which greatly improves the pot life of the epoxy resin composition without reducing the curing reactivity. Moreover, a molded article with higher wet heat resistance and/or higher toughness is produced due to the rigid structure of oxazolidone ring preferentially formed over the other in the backbone of the molecule after the curing reaction. In cases where the peak temperature of the exothermic reaction is higher than the temperature 15° C. lower than Tb, hydroxyl groups present in the thermosetting epoxy resin composition may react with the isocyanate curing agent preferentially over the hydroxyl group capping agent, which results in the urethane-forming reaction between the isocyanate curing agent and the hydroxyl groups and may compromise both the pot life and fast curability at low temperatures. Additionally, a urethane structure(s) with low wet resistance can be formed in a molded article, and the molded article may therefore be insufficient in terms of wet heat resistance and toughness.

In the present invention, the peak temperature Te of the exothermic reaction between the component [e] and a hydroxyl group means the temperature at which the capping reaction of hydroxyl groups is allowed to proceed most vigorously in cases where the component [e] and a specific hydroxy-containing compound are mixed with each other and heated at a constant rate. Specifically, 1-phenoxy-2-propanol is prepared as a hydroxy-containing compound that mimics an epoxy resin containing hydroxyl groups. The hydroxy-containing compound and the component [e] are mixed in a mass ratio of 10:1, and differential scanning calorimetry (DSC) is performed on the mixture at a rate of temperature increase of 10° C./min. The peak temperature of the obtained exothermic curve is the exothermic peak temperature Te of the hydroxyl group capping reaction.

In the present invention, the peak temperature Tb of the exothermic reaction between the component [b] and a hydroxyl group means the temperature at which the urethane-forming reaction between the hydroxyl group and the isocyanate group of the component [b] is allowed to proceed most vigorously in cases where the component [b] and a specific hydroxy-containing compound are mixed with each other and heated at a constant rate. Specifically, 1-phenoxy-2-propanol is prepared as a hydroxy-containing compound that mimics an epoxy resin containing hydroxyl groups. The hydroxy-containing compound and the component [b] are mixed in a mass ratio of 10:1, and differential scanning calorimetry (DSC) is performed on the mixture at a rate of temperature increase of 10° C./min. The peak temperature of the obtained exothermic curve is the exothermic peak temperature Tb of the urethane-forming reaction.

In the present invention, the content of the component [e] in total is preferably not less than 0.5 part by mass and not more than 20 parts by mass, more preferably not less than 1 part by mass and not more than 15 parts by mass, still more preferably not less than 1 part by mass and not more than 10 parts by mass, relative to 100 parts by mass of the component [a] in total. In cases where the content of the component [e] is less than 0.5 part by mass, the pot life may not be enough long, and the wet heat resistance and toughness of a molded article may be insufficient. On the other hand, in cases where the content of the component [e] is more than 20 parts by mass, the fast curability at low temperatures may be insufficient, and the wet heat resistance of a molded article may be insufficient.

Preferably, in the present invention, the component [e] is an isocyanate compound that contains at least one isocyanate group in the molecule, a compound that contains at least one carbodiimide group in the molecule, a compound that contains at least one acid anhydride structure in the molecule, an orthoester compound, an alkoxysilane compound, or an oxazolidine compound from the viewpoint of the reactivity with hydroxyl groups. More preferably, the component [e] comprise at least one compound selected from the group consisting of the following compounds [I] to [III] because the compound can reduce the increase of viscosity during capping of hydroxyl groups:
[I] a compound that contains at least one isocyanate group in the molecule;
[II] a compound that contains at least one carbodiimide group in the molecule;
[III] a compound that contains at least one acid anhydride structure in the molecule.

Still more preferably, the component [e] comprises [I] a compound that contains at least one isocyanate group in the molecule, among others.
[I]: Examples of the compound that contains at least one isocyanate group in the molecule include aliphatic isocyanates, such as methyl isocyanate, ethyl isocyanate, n-propyl isocyanate, isopropyl isocyanate, n-butyl isocyanate, isobutyl isocyanate, octadecyl isocyanate, cyclohexyl isocyanate, chlorosulfonyl isocyanate, methylene diisocyanate, ethylene diisocyanate, trimethylene diisocyanate, dodecamethylene diisocyanate, hexamethylene diisocyanate, tetramethylene diisocyanate, pentamethylene diisocyanate, propylene diisocyanate, 2,3-dimethyltetramethylene diisocyanate, butylene-1,2-diisocyanate, butylene-1,3-diisocyanate, 1,4-diisocyanate hexane, cyclopentene-1,3-diisocyanate, 1,2,3,4-tetraisocyanate butane, and butane-1,2,3-triisocyanate; aromatic isocyanates, such as phenyl isocyanate, tolyl isocyanate, xylyl isocyanate, trimethylphenyl isocyanate, acetylphenyl isocyanate, ethoxyphenyl isocyanate, cyanophenyl isocyanate, dimethoxyphenyl isocyanate, naphthyl isocyanate, biphenylyl isocyanate, phenoxyphenyl isocyanate, fluorophenyl isocyanate, chlorophenyl isocyanate, bromophenyl isocyanate, benzenesulfonyl isocyanate, o-toluenesulfonyl isocyanate, p-toluenesulfonyl isocyanate, p-phenylene diisocyanate, 1-methylphenylene-2,4-diisocyanate, naphthalene-1,4-diisocyanate, tolylene diisocyanate, diphenyl-4,4-diisocyanate, benzene-1,2,4-triisocyanate, xylylene diisocyanate, α,α,α′,α′-tetramethylxylylene diisocyanate, diphenylmethane diisocyanate (MDI), diphenylpropane diisocyanate, tetramethylene xylene diisocyanate, and polymethylene polyphenyl isocyanate; and alicyclic isocyanates, such as methylene diisocyanate, lysine diisocyanate, cyclohexane diisocyanate, methylcyclohexane diisocyanate, trimethylhexamethylene diisocyanate, isophorone diisocyanate, methylene-bis(4-cyclohexylisocyanate), and isopropylidene-dicyclohexyl diisocyanate.

It is preferred that the component [e] comprise a compound that contains at least one isocyanate group in the molecule, among others, because the compound can reduce the increase of viscosity during capping of hydroxyl groups. Examples of the compound that contains one isocyanate group in the molecule include methyl isocyanate, ethyl isocyanate, n-propyl isocyanate, isopropyl isocyanate, n-butyl isocyanate, isobutyl isocyanate, octadecyl isocyanate, cyclohexyl isocyanate, chlorosulfonyl isocyanate, phenyl isocyanate, chlorophenyl isocyanate, tolyl isocyanate, xylyl isocyanate, trimethylphenyl isocyanate, acetylphenyl isocyanate, ethoxyphenyl isocyanate, cyanophenyl isocyanate, dimethoxyphenyl isocyanate, naphthyl isocyanate, biphenylyl isocyanate, phenoxyphenyl isocyanate, fluorophenyl isocyanate, bromophenyl isocyanate, benzenesulfonyl isocyanate, o-toluenesulfonyl isocyanate, and p-toluenesulfonyl isocyanate. Among those, sulfonyl isocyanate compounds, such as chlorosulfonyl isocyanate, benzenesulfonyl isocyanate, o-toluenesulfonyl isocyanate, and p-toluenesulfonyl isocyanate, are more suitable for use from the viewpoint of heat resistance.
[II]: Examples of the compound that contains at least one carbodiimide group in the molecule include dicarbodiimides, such as N,N′-diisopropylcarbodiimide, N,N′-dicyclohexylcarbodiimide, and N,N′-di-2,6-diisopropylphenylcarbodiimide; and polycarbodiimides, such as poly(1,6-hexamethylenecarbodiimide), poly[4,4′-methylene bis(cyclohexylcarbodiimide)], poly(1,3-cyclohexylene carbodiimide), poly(1,4-cyclohexylene carbodiimide), poly(4,4′-dicyclohexylmethanecarbodiimide), poly(4,4′-diphenylmethanecarbodiimide), poly(3,3′-dimethyl-4,4′-diphenylmethanecarbodiimide), poly(naphthalenecarbodiimide), poly(p-phenylenecarbodiimide), poly(m-phenylenecarbodiimide), poly(tolylcarbodiimide), poly(diisopropylcarbodiimide), poly(methyl-diisopropylphenylenecarbodiimide), poly(1,3,5-triisopropylbenzene) polycarbodiimide, poly(1,3,5-triisopropylbenzene) polycarbodiimide, poly(1,5-diisopropylbenzene) polycarbodiimide, poly(triethylphenylenecarbodiimide), and poly(triisopropylphenylenecarbodiimide).
[III]: Examples of the compound that contains at least one acid anhydride structure in the molecule include acetic anhydride, chloroacetic anhydride, dichloroacetic anhydride, trichloroacetic anhydride, trifluoroacetic anhydride, propionic anhydride, butyric anhydride, succinic anhydride, maleic anhydride, benzoic anhydride, phthalic anhydride, methyltetrahydrophthalic anhydride, hexahydrophthalic anhydride, methyl hexahydrophthalic anhydride, tetrahydrophthalic anhydride, methyl-tetrahydro-endomethylenephthalic anhydride, tetrahydro-endomethylenephthalic anhydride, methyl-bicycloheptanedicarboxylic acid anhydride, and bicycloheptanedicarboxylic acid anhydride.

The hydroxyl group capping agent is not limited to the above compounds. Additionally, those hydroxyl group capping agents may be used singly or in combination of two or more.

A thermosetting epoxy resin-based molded article (hereinafter sometimes simply referred to as “molded article”) according to the present invention will be described in details.

The first aspect of the thermosetting epoxy resin-based molded article of the invention is prepared by thermally curing the thermosetting epoxy resin composition of the invention. By the thermal curing of the thermosetting epoxy resin composition of the invention, the molded article is allowed to have excellent toughness and to exhibit high and stable stiffness in a wide temperature range from low to high temperature. Curing conditions such as curing temperature and curing time are appropriately determined depending on the catalyst type and the catalyst amount.

The second aspect of the thermosetting epoxy resin-based molded article of the invention comprises microdomains with an absorbance ratio Da/(Da+db) in the range from 0.55 to 1 and a Tg′ of −30° C. or lower.

In cases where the absorbance ratio Da/(Da+db) is in the range from 0.55 to 1, preferably in the range from 0.6 to 1, and more preferably in the range from 0.7 to 1, the molded article contains a large enough amount of oxazolidone rings and therefore has a low enough cross-linking density and high plastic deformation capacity. This enhances the effect of the added component [c] to increase the toughness and also ensures a high enough increase in toughness even if the added component [c] is small in amount. In cases where the absorbance ratio Da/(Da+db) is less than 0.55, the molded article contains an excessively low amount of oxazolidone rings and therefore has an extremely high cross-linking density and low toughness. Preferably, a molded article with an absorbance ratio Da/(Da+db) closer to 1 tends to have a more appropriate cross-linking density and more excellent heat resistance.

The absorbance ratio is determined by calculating an absorbance ratio Da/(Da+db) from the absorbance Da of the C═O double bond in the carboxyl group of an oxazolidone ring and the absorbance db of the C═O double bond in the carboxyl group of an isocyanurate ring measured by the FT-IR/ATR method.

More specifically, the absorbance ratio means the value of the absorbance ratio Da/(Da+db) calculated from the absorbance Da of the C═O double bond in the carboxyl group of an oxazolidone ring and the absorbance db of the C═O double bond in the carboxyl group of an isocyanurate ring measured in a cured product of an epoxy resin composition by using attenuated total reflection (hereinafter sometimes simply referred to as “ATR”) FT-IR. For example, the absorbance ratio can be calculated from the absorbance Da at around 1760 cm⁻¹ and the absorbance db at around 1710 cm⁻¹, which are measured by the FT-IR/ATR method at a resolution of 4 cm⁻¹ with a scan number of 32.

The third aspect of the thermosetting epoxy resin-based molded article of the invention satisfies the relationship between the glass transition temperature Tg and the rubbery modulus Gr expressed by the formula 1 and comprises microdomains with a glass transition temperature Tg′ of −30° C. or lower:

Tg≥10×Gr+130 (Formula 1).

In cases where the relationship between Tg and Gr satisfies the formula 1, preferably the formula 1a, and more preferably the formula 1b, the molded article has a relatively low cross-linking density and well-balanced properties of heat resistance and plastic deformation capacity. This enhances the effect of the added component [c] to increase the toughness, with maintaining high heat resistance, and also ensures a high enough increase in toughness even if the added component [c] is small in amount. It is preferred that the relationship between Gr and Tg also satisfy the formula 1′.

Tg≥10×Gr+140 (Formula 1a);

Tg≥10×Gr+144 (Formula 1b);

Tg≤10×Gr+230 (Formula 1′).

Moreover, in the thermosetting epoxy resin-based molded article of the invention, the rubbery modulus Gr is preferably in the range from 0.5 MPa to 15 MPa. In cases where the rubbery modulus Gr is in the range from 0.5 MPa to 15 MPa, more preferably in the range from 0.5 MPa to 10 MPa, and still more preferably in the range from 0.5 MPa to 5 MPa, the molded article has a low cross-linking density, which enhances the effect of the added component [c] to increase the toughness and also ensures a high enough increase in toughness even if the added component [c] is small in amount. In cases where Gr is less than 0.5 MPa, the molded article may have poor heat resistance. On the other hand, in cases where Gr is more than 15 MPa, the molded article may have poor toughness.

The microdomains that the second and third aspects of the thermosetting epoxy resin-based molded article of the invention comprise are not specifically limited, provided that the microdomains have a Tg′ of −30° C. or lower. The microdomains are in a rubber state at normal temperatures and are therefore firstly disrupted, for example, upon application of open-mode stress, and the disruption results in elimination of the plane strain condition in the system and a great increase of the toughness in the molded article.

The Tg′ of microdomains can be calculated from values of storage modulus and loss tangent that are determined from dynamic viscoelasticity measurements for the molded article heated from a low temperature using a dynamic viscoelasticity-measuring apparatus. Additionally, the glass transition temperature of microdomains can be directly measured by nanoscale thermal analysis using an atomic force microscope in cases of failure to determine the Tg′ by the above method for any reason.

In the thermosetting epoxy resin-based molded article of the invention, the volume fraction of the microdomains is preferably from 0.2% to 8% by volume, more preferably from 0.2% to 4% by volume, and still more preferably from 0.2% to 2% by volume. In cases where the volume fraction is less than 0.2% by volume, the extent of increased toughness may be insufficient. On the other hand, in cases where the volume fraction is more than 8% by volume, a problem of reduced heat resistance or stiffness may occur. The volume fraction of the microdomains can be determined by cutting the molded article in an arbitrary plane to expose a cross-section and measuring the ratio of the area of observed microdomains in the cross-section to the area of the cross-section, where the area of the cross-section is taken as 100.

In the thermosetting epoxy resin-based molded article of the invention, each microdomain is preferably a dispersed phase with a diameter of 0.01 to 30 micrometers, more preferably a dispersed phase with a diameter of 0.01 to 3 micrometers, and still more preferably a dispersed phase with a diameter of 0.01 to 0.3 micrometer. In cases where the dispersed phase is less than 0.01 micrometer in size, a problem of reduced heat resistance or stiffness may occur. On the other hand, in cases where the dispersed phase is more than 30 micrometers in size, the extent of increased toughness may be insufficient. In cases where the microdomains are formed as a continuous phase but not as dispersed phase, a problem of reduced stiffness may occur.

In the present invention, the dispersed phases refer to non-continuous phases present in a continuous phase of a matrix resin and are not limited to spherical shapes but may have an indefinite shape. The size of the dispersed phases refers to the diameter of the inscribed circle of the smallest dispersed phase observed in a cross-section of the molded article.

In the thermosetting epoxy resin-based molded article of the invention, the microdomains preferably have a dispersion of not more than 1.0, more preferably not more than 0.8, and still more preferably not more than 0.6. A smaller value of dispersion indicates a more uniform dispersion. In cases where the dispersion is more than 1.0, the molded article may have insufficient toughness.

The dispersion of microdomains refers to a coefficient variation obtained by dividing the standard deviation of the areas of cells by the mean of the areas of the cells, wherein the cells are defined through a Voronoi tessellation of the centroids of microdomains observed in a cross-section of the molded article and plotted on the X-Y coordinate plane. Specifically, the dispersion can be calculated as a coefficient variation obtained by imaging the molded article with a transmission electron microscope, analyzing the obtained image by the Image Pro Premier 3D image analysis software (produced by Media Cybernetics, Inc.) to extract the coordinate of microdomains, defining cells through a Voronoi tessellation of the centroids of the microdomains, and dividing the standard deviation of the areas of the cells by the mean of the areas of the cells to calculate the coefficient variation.

The cross-sectional observation of the molded article is not limited to a specific method, and examples of the method for the cross-sectional observation include a method in which the molded article is polished to expose a cross-section and the resulting cross-section is observed under an optical microscope or a scanning electron microscope, a method in which the molded article is cut in the cross-sectional direction to prepare an ultra-thin section and the resulting ultra-thin section is observed under a transmission electron microscope, and the like.

A molding material for fiber-reinforced composite material according to the present invention comprises the thermosetting epoxy resin composition of the invention and a reinforcing fiber. The presence of the reinforcing fiber achieves both light weight and excellent mechanical properties.

The first aspect of the fiber-reinforced composite material according to the present invention is prepared by thermally curing the molding material for fiber-reinforced composite material according to the present invention. By the thermal curing of the thermosetting epoxy resin composition contained in the molding material for fiber-reinforced composite material according to the present invention, the fiber-reinforced composite material is allowed to have excellent toughness and to exhibit high and stable stiffness in a wide temperature range from low to high temperature. Curing conditions such as curing temperature and curing time are appropriately determined depending on the catalyst type and the catalyst amount.

The second aspect of the fiber-reinforced composite material according to the present invention comprises the thermosetting epoxy resin-based molded article of the invention and a reinforcing fiber. The presence of the reinforcing fiber achieves both light weight and excellent mechanical properties.

The molding material for fiber-reinforced composite material according to the present invention is not limited to a specific molding material as long as the molding material comprises a reinforcing fiber and a thermosetting epoxy resin composition, and the reinforcing fiber may or may not yet have been impregnated with the epoxy resin composition. Additionally, the epoxy resin composition may not yet have been cured or may have been partially cured to the B-stage.

The fiber-reinforced composite material according to the present invention is not limited to a specific fiber-reinforced composite material as long as the fiber-reinforced composite material comprises a reinforcing fiber and a molded article prepared by thermally curing the thermosetting epoxy resin composition. However, a fiber-reinforced composite material prepared by thermally curing the above molding material for fiber-reinforced composite material is preferred.

The production of the fiber-reinforced composite material according to the present invention is not limited to a specific method, but a high-throughput production method such as the RTM (resin transfer molding) method, the resin film infusion method, the pultrusion method, or the press forming method, is suitable for use. Among those, the RTM method and the pultrusion method are more preferably used, and the RTM method is particularly preferably used.

The first aspect of the method of the invention for producing a fiber-reinforced composite material comprises impregnating reinforcing fibers with the thermosetting epoxy resin of the invention and then curing the thermosetting epoxy resin by heat. In the method of producing a fiber-reinforced composite material, it is preferred that reinforcing fibers be continuously pulled through an impregnation bath of the thermosetting epoxy resin composition and then through a squeeze die and a heating mold by a pulling machine, where the impregnated fibers are molded and cured. Additionally, the molded article may be post-cured to increase the heat resistance or complete the reaction of epoxy groups. The molded article may be cured in a curing oven placed on the line after the molded article is discharge from the mold and before the molded article is wound up or can be cured in an oven after the molded article is wound up.

The second aspect of the method of the invention for producing a fiber-reinforced composite material comprises placing a woven fabric composed primarily of reinforcing fibers into a mold, impregnating the woven fabric with the thermosetting epoxy resin composition of the invention injected into the mold, and then curing the thermosetting epoxy resin composition by heat. The phrase “composed primarily of” refers to a component that accounts for the largest proportion in mass among the components of the woven fabric.

In the second aspect of the method of the invention for producing a fiber-reinforced composite material, it is preferred that the thermosetting epoxy resin composition be injected through multiple injection ports into the mold for impregnating the woven fabric composed primarily of reinforcing fibers placed in the mold with the thermosetting epoxy resin composition. Specifically, a variety of molded articles with different shapes and sizes can preferably be provided by using a mold with multiple injection ports and selecting optimal injection conditions according to a desired fiber-reinforced composite material, such as injecting the thermosetting epoxy resin composition through the multiple injection ports simultaneously or sequentially with time intervals. The number and shape of the injection ports are not limited, but it is convenient that more injection ports enable the injection to be completed in a shorter time, and it is preferred that the injection ports be positioned to provide a short flow length of the resin depending on the shape of a molded article.

A pressure from 0.1 MPa to 1.0 MPa is normally used to inject the thermosetting epoxy resin composition, and an injection pressure from 0.1 MPa to 0.6 MPa is preferred in terms of injection time and economy of equipment utilization. Moreover, the VaRTM (vacuum-assisted resin transfer molding) method can also be used, in which the thermosetting epoxy resin composition is injected into a mold under vacuum. Even in cases of high-pressure injection, it is advantageous that a mold is vacuumed before injection of the thermosetting epoxy resin composition to reduce the generation of voids.

As the reinforcing fiber used in the present invention, glass fiber, aramid fiber, carbon fiber, boron fiber, or the like is suitable for use. Among those, carbon fiber is suitable for use because a fiber-reinforced composite material that is not only light in weight but also has excellent mechanical properties such as strength and elastic modulus can be produced.

Preferably, the carbon fiber has a substantially circular cross-section. By the “substantially circular cross-section” is meant that the ratio of the minor axis r to the major axis R (r/R) is not less than 0.9, where the lengths of the minor and major axes of the cross-section are measured on a cross-section of a single filament by using an optical microscope. The major axis R refers to the diameter of the circumscribed circle of the cross-section of the single filament, and the minor axis r refers to the diameter of the inscribed circle of the cross-section of the single filament. When the cross-section is a perfect circle, a matrix of such carbon fibers is well impregnated with the thermosetting epoxy resin composition, and the risk of leaving unimpregnated areas can be reduced.

The carbon fiber preferably has an average fiber diameter in the range from 4.0 μm to 8.0 μm, more preferably from 5.0 μm to 7.0 μm, and still more preferably from 5.3 μm to 7.0 μm when the fiber diameter is measured using an optical microscope. The average fiber diameter in the above range allows both the impact resistance and the tensile strength to be achieved in a fiber-reinforced composite material in which the carbon fiber is used.

Preferably, the carbon fiber further satisfies the following condition [c]:

[c] the carbon fiber has a surface oxygen concentration O/C ranging from 0.03 to 0.22.

In this respect, the surface oxygen concentration is determined in X-ray photoelectron spectroscopy by calculating the surface oxygen concentration O/C═([O₁ₛ]/[C₁ₛ])/(sensitivity correction value) from the O₁ₛ peak area [O₁ₛ] and the C₁ₛ peak area [C₁ₛ]. The surface oxygen concentration O/C is more preferably in the range from 0.05 to 0.22 and still more preferably in the range from 0.08 to 0.22. In cases where the O/C is not more than 0.22, a fiber-reinforced composite material in which such a carbon fiber is used is more likely to have sufficient tensile strength. In cases where the O/C is not less than 0.03, the adhesiveness of such a carbon fiber with the thermosetting epoxy resin composition is improved, and a fiber-reinforced composite material in which such a carbon fiber is used is more likely to have sufficient mechanical properties. Examples of a technique for limiting the surface oxygen concentration O/C to the above range include a method of changing the type or concentration of an electrolyte used for or the quantity of electricity applied for the electrolytic oxidation.

The carbon fiber can be used in combination with, for example, an inorganic fiber, such as glass fiber, metal fiber, or ceramic fiber, or a synthetic organic fiber, such as polyamide fiber, polyester fiber, polyolefin fiber, or novoloid fiber, or a metal wire made of, for example, gold, silver, copper, bronze, brass, phosphor bronze, aluminium, nickel, steel, or stainless steel, or a metal mesh, or a metal non-woven fabric, as long as the effects of the invention are not impaired.

The content of the carbon fiber is preferably not less than 30% by mass, more preferably not less than 50% by mass, still more preferably not less than 70% by mass, of the total fibers. In cases where the content of the carbon fiber is within the above range, a fiber-reinforced composite material with light weight and excellent mechanical properties can be preferably obtained.

A glass fiber is suitable for use as the reinforcing fiber because the glass fiber allows for cost and weight savings in fiber-reinforced composite material for automobiles, aircrafts, and large members, such as a wind turbine blade.

The glass fiber is preferably a glass fiber having a surface functional group capable of forming a covalent bond to an isocyanate group. It is known that silicon-bonded hydroxyl groups (Si—OH) called silanol groups are on the surface of glass fibers, and that the surface chemical properties of glass fibers can be improved by attaching a coupling agent with a different functional group, as needed, to the silanol group. By the phrase “having a surface functional group capable of forming a covalent bond to an isocyanate group” is meant at least one functional group capable of reacting with an isocyanate group to form a covalent bond resides on the surface of glass fibers. In cases where glass fibers have a surface functional group capable of forming a covalent bond with an isocyanate group, the glass fibers can form a chemical linkage with an isocyanate curing agent contained as the component [b] in the thermosetting epoxy resin composition, by which the adhesiveness of the glass fibers with the thermosetting epoxy resin composition is increased in the resulting fiber-reinforced composite material and the strength is more likely increased. However, in cases where the adhesiveness of the glass fibers with the epoxy resin composition is too high, the impact resistance may be reduced, as described below. Therefore, it is preferred that the surface of the glass fibers be appropriately treated with a coupling agent or the like.

Preferably, the surface functional group of the glass fiber is at least one functional group selected from the group consisting of hydroxyl group, oxirane group, amino group, thiol group, and carboxy group. The presence of the surface functional group as described above on the surface of the glass fiber is more likely to provide excellent adhesion at the interface between the glass fiber and the thermosetting epoxy resin composition. Among those, amino group is preferred as the surface functional group of the glass fiber because amino group is compatible with the epoxy resin composition and is moderately likely to form a covalent bond with the isocyanate curing agent [b].

Preferably, a functional group with an active hydrogen resides on the surface of the glass fiber. The active hydrogen refers to a highly reactive hydrogen atom that is bound to a nitrogen, oxygen, or sulfur atom in an organic compound. For example, one amino group contains two active hydrogens. Examples of the functional group with an active hydrogen include hydroxyl group, amino group, thiol group, and carboxy group.

Preferably, the surface functional group of the glass fiber is formed by treatment with at least one selected from the group consisting of a silane coupling agent, a titanate coupling agent, an aluminate coupling agent, and a zirconium coupling agent. The coupling agents may be used singly or in combination of two or more. In cases where the amount of silanol groups on the surface of a glass fiber is too high, the glass fiber is firmly attached by a chemical bond to the isocyanate curing agent [b]contained in the epoxy resin composition and the adhesiveness is increased, but the epoxy resin may be fractured without gaining the benefit of the strength of the glass fiber when a tensile stress is applied to the resulting fiber-reinforced composite material, which results in reduction of tensile strength. Therefore, it is preferred that the surface of the glass fibers be appropriately treated with a coupling agent or the like.

Examples of the silane coupling agent that is used for glass fibers can include amino-containing silanes, such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-ureidopropyltrimethoxysilane, N-phenyl-γ-aminopropyltrimethoxysilane, N-benzyl-γ-aminopropyltrimethoxysilane, and N-vinylbenzyl-γ-aminopropyltriethoxysilane; thiol-containing silanes, such as γ-mercaptopropyltrimethoxysilane, γ-mercaptopropyltriethoxysilane, γ-mercaptopropylmethyldimethoxysilane, and γ-mercaptopropylmethyldiethoxysilane; oxirane-containing silanes, such as γ-glycidoxypropyltrimethoxysilane, γ-glycidoxypropyltriethoxysilane, γ-glycidoxypropylmethyldimethoxysilane, β-(3,4-epoxycyclohexyl)ethyltrimethoxysilane, and β-(3,4-epoxycyclohexyl)ethyltriethoxysilane; and carboxy-containing silanes, such as β-carboxyethyltriethoxysilane, β-carboxyethylphenylbis(2-methoxyethoxy)silane, and N-β-(carboxymethyl)aminoethyl-γ-aminopropyltrimethoxysilane.

Examples of the titanate coupling agent include isopropyl tri(N-aminoethyl-aminoethyl)titanate, tetraoctyl bis(ditridecylphosphite)titanate, tetra(2,2-diallyloxymethyl-1-butyl) bis(ditridecyl phosphite)titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridecylbenzenesulfonyl titanate, isopropylisostearoyldiacryl titanate, isopropyltri(dioctylphosphate)titanate, isopropyltricumylphenyl titanate, and tetraisopropylbis(dioctylphosphite)titanate.

Among those, an amino-containing silane is preferred as the silane coupling agent because an amino-containing silane is compatible with the epoxy resin composition and can moderately increase the adhesive strength and impact resistance.

In cases where the glass fiber comprises a coupling agent, the content of the coupling agent is preferably from 0.01 part to 5 parts by mass, more preferably from 0.05 part to 4 parts by mass, still more preferably from 0.1 part to 3 parts by mass, relative to 100 parts by mass of the glass fiber. In cases where the content of the coupling agent is within the above range, the wettability of the thermosetting epoxy resin composition to the glass fiber is improved, and the adhesiveness and impregnating property of the thermosetting epoxy resin composition are moderately increased, and a fiber-reinforced composite material with higher mechanical properties can be preferably obtained.

Examples of a method of forming a coupling agent layer include a method in which a solution containing a coupling agent is applied on the surface of a matrix of glass fibers and then treated by heat. A solvent is used for preparing the solution of the coupling agent, and the solvent is not limited to a specific solvent as long as the solvent will not react with the coupling agent. Examples of the solvent include aliphatic hydrocarbon solvents, such as hexane; aromatic solvents, such as benzene, toluene, and xylene; ether solvents, such as tetrahydrofuran; alcohol solvents, such as methanol and propanol; ketone solvents, such as acetone; and water. These solvents are used singly or in combination of two or more.

As the glass fiber, any type of glass fiber can be used depending on applications. Examples of the glass fiber include E-glass fibers, A-glass fibers, C-glass fibers, D-glass fibers, R-glass fibers, S-glass fibers, ECR-glass fibers, NE-glass fibers, quartz fibers, and fibers prepared from glass compositions that can be used for fiber production, which are commonly known as fluorine-free and/or boron-free E-grass derivatives.

The glass fibers can be used in combination with, for example, an inorganic fiber, such as carbon fiber, metal fiber, or ceramic fiber, a synthetic organic fiber, such as polyamide fiber, polyester fiber, polyolefin fiber, or novoloid fiber, a metal wire made of, for example, gold, silver, copper, bronze, brass, phosphor bronze, aluminium, nickel, steel, or stainless steel, or a metal mesh, or a metal non-woven fabric, as long as the effects of the invention are not impaired.

The content of the glass fiber is preferably not less than 30% by mass, more preferably not less than 50% by mass, still more preferably not less than 70% by mass, of the total fibers. In cases where the content of the glass fiber is within the above range, a fiber-reinforced composite material with light weight and excellent mechanical properties and weather resistance can be preferably obtained.

The reinforcing fiber may be either a short fiber or a continuous fiber or can be a combination of both the fibers. A continuous fiber is preferred to obtain a fiber-reinforced composite material with excellent mechanical properties and a high fiber volume content (Vf).

In the fiber-reinforced composite material according to the present invention, the reinforcing fiber can be used in the form of strands, but a matrix of reinforcing fibers formed into a mat, a woven fabric, a knit, a braid, a unidirectional sheet, or the like is suitable for use. Among those, a woven fabric is suitable for use because a woven fabric is likely to give a fiber-reinforced composite material with a high Vf and is easy to handle.

### EXAMPLES

The present invention will be described in more details by the following examples, but the present invention is not limited to the examples.

Examples 1 to 14 and Comparative Examples 1 to 7 are as follows (including Table 1). In this specification, Table 1 includes Tables 1-1 to 1-4.

### (1) Raw Materials for Epoxy Resin Compositions

The following raw materials were used to obtain the epoxy resin compositions of the examples.

[a] Epoxy Resin
“Epotohto (registered trademark)” YD-8125 (bisphenol A-type epoxy resin, epoxy equivalent weight: 173, manufactured by Nippon Steel Chemical & Material Co., Ltd.)
“ARALDITE (registered trademark)” MY721 (tetraglycidyl diaminodiphenylmethane, epoxy equivalent weight: 113, manufactured by Huntsman Advanced Materials)
   [b] Isocyanate Curing Agent
“Lupranate (registered trademark)” M20S (polymeric MDI, isocyanate equivalent weight: 134, manufactured by BASF INOAC Polyurethanes Ltd.)
“Lupranate (registered trademark)” MI (Monomeric MDI, isocyanate equivalent weight: 126, manufactured by BASF INOAC Polyurethanes Ltd.)
   [c] Elastomeric Toughening Agent
“Nanostrength” E20F (SBM block copolymer, manufactured by Arkema S.A.)
“Nanostrength” M22N (MAM block copolymer, manufactured by Arkema S.A.)
“KANE ACE” MX-154 (40% by weight masterbatch of core shell rubber particles having a polybutadiene backbone and dispersed in bisphenol A-type epoxy resin, epoxy equivalent weight: 301, manufactured by Kaneka Co.)
   [d] Oxazolidone Cyclization Catalyst
TBAB (tetrabutylammonium bromide, manufactured by Tokyo Chemical Industry Co., Ltd.)
TBD/dichloroacetic acid

A white solid obtained by mixing equimolar amounts of TBD (1,5,7-triazabicyclo[4.4.0]dec-5-ene, manufactured by Tokyo Chemical Industry Co., Ltd.) and dichloroacetic acid (manufactured by Tokyo Chemical Industry Co., Ltd.) to a homogeneous blend.

[e] Hydroxyl Group Capping Agent
Chlorophenyl isocyanate (4-chlorophenyl isocyanate, manufactured by Tokyo Chemical Industry Co., Ltd.)
Toluenesulfonyl isocyanate (p-toluenesulfonyl isocyanate, manufactured by Tokyo Chemical Industry Co., Ltd.)
Chloroacetic anhydride (manufactured by Tokyo Chemical Industry Co., Ltd.)
   Others than [a] to [e]
“Lonzacure (registered trademark)” M-DEA (tetraethyl diaminodiphenylmethane, manufactured by Lonza K.K.)
“DBU (registered trademark)” (1,8-diazabicyclo[5.4.0]undec-7-ene, manufactured by San-Apro Ltd.)
Imidazolium salt (1-ethyl-3-methylimidazolium diethyl phosphate, manufactured by Tokyo Chemical Industry Co., Ltd.)

### (2) Preparation of Thermosetting Epoxy Resin Compositions

A thermosetting epoxy resin composition was prepared according to the number of parts (parts by mass) specified in the composition column in Table 1. Specifically, an epoxy resin and an elastomeric toughening agent were combined, stirred at 150° C. for 1 hour, and then returned to a normal temperature. An oxazolidone cyclization catalyst was added to the mixture, and the oxazolidone cyclization catalyst was dissolved by stirring the mixture at a temperature equal to or above the melting point of the oxazolidone cyclization catalyst before an isocyanate curing agent was added and dissolved to homogeneity.

### (3) Production of Thermosetting Epoxy Resin-Based Molded Articles

Each epoxy resin composition prepared in the above subsection (2) was vacuumed for defoaming and then using a compression molding machine, under a pressing pressure of 1 MPa, heated at a rate of 10° C./min from a normal temperature to, 230° C., followed by demolding to produce plate-like molded articles with thicknesses of 2 mm and 6 mm.

### (4) Measurement of the Glass Transition Temperature Tg and Rubbery Modulus Gr of Thermosetting Epoxy Resin-Based Molded Articles

A test piece with a size of 10 mm in width×40 mm in length was cut from each 2-mm-thick molded article produced in the above subsection (3), and the test piece was placed in a solid screw clamp and then subjected to dynamic viscoelasticity measurement in the temperature range from 30° C. to 300° C. by using a dynamic viscoelasticity-measuring apparatus (ARES: manufactured by TA instruments, Inc.) at a rate of temperature increase of 5° C./min, a frequency of 1 Hz, and a strain of 0.1%. In a scatter plot with common logarithm of storage modulus on the vertical axis and temperature on the horizontal axis, the temperature at the intersection between the tangent to the curve in the glass range and the tangent to the curve in the glass transition range was determined as the glass transition temperature Tg. Moreover, the storage modulus G′ at a temperature of 50° C. above the Tg measured as described above was determined as the rubbery modulus Gr.

### (5) Measurement of the Dispersion Size, Volume Fraction, and Dispersion of Microdomains

A ultra-thin section was sliced from each 2-mm-thick molded article produced in the above subsection (3) and observed for morphological characteristics by using a transmission electron microscope. An inscribed circle of the smallest observed microdomain was drawn, and the diameter of the inscribed circle was determined. The same operation was performed on arbitrarily selected 100 microdomains, and the average of the diameters was determined as the dispersion size of the microdomains.

A region including 100 or more microdomains was arbitrarily selected from the transmission electron microscope image, and the ratio of the area of the observed microdomains in this region was determined as the volume fraction of the microdomains.

A region including 100 or more microdomains was arbitrarily selected from the transmission electron microscope image, and microdomains were extracted from the image of the region by using the “Image Pro Premier 3D” image analysis software produced by Media Cybernetics to define cells through a Voronoi tessellation of the centroids of the microdomains, and the coefficient variation obtained by dividing the standard deviation of the areas of the cells by the mean of the areas of the cells was determined as the dispersion of microdomains.

### (6) Measurement of the Glass Transition Temperature Tg′ of Microdomains

A test piece with a size of 10 mm in width×40 mm in length was cut from each 2-mm-thick molded article produced in the above subsection (3), and the test piece was placed in a solid screw clamp and then subjected to dynamic viscoelasticity measurement in the temperature range from −100° C. to 120° C. by using a dynamic viscoelasticity-measuring apparatus (ARES: manufactured by TA instruments, Inc.) at a rate of temperature increase of 5° C./min, a frequency of 1 Hz, and a strain of 0.1%. In a scatter plot with common logarithm of loss tangent on the vertical axis and temperature on the horizontal axis, the temperature at the peak of loss tangent caused by microdomains was determined as the glass transition temperature of microdomains Tg′.

### (7) Measurement of the Stiffness of Thermosetting Epoxy Resin-Based Molded Articles

A test piece with a size of 10 mm in width×40 mm in length was cut from each 2-mm-thick molded article produced in the above subsection (3), and the test piece was placed in a solid screw clamp and then subjected to dynamic viscoelasticity measurement in the temperature range from −100° C. to 120° C. by using a dynamic viscoelasticity-measuring apparatus (ARES: manufactured by TA instruments, Inc.) at a rate of temperature increase of 5° C./min, a frequency of 1 Hz, and a strain of 0.1%. The storage modulus G′ at −50° C., the storage modulus G′ at 25° C., and the storage modulus G′ at 120° C. were determined as the low-temperature stiffness, the normal-temperature stiffness, and the high-temperature stiffness, respectively. The retention rate (%) of high-temperature stiffness relative to low-temperature stiffness was determined as the stiffness retention.

### (8) Measurement of the Toughness of Thermosetting Epoxy Resin-Based Molded Articles

A test piece with a size of 12.7 mm in width and 150 mm in length was cut from each 6-mm-thick molded article produced in the above subsection (3), and the three-point bending test was performed on the piece of resin with a notch according to ASTM D5045-1999, and the obtained critical stress intensity factor K_{IC} was determined as the toughness.

The balance between toughness and stiffness retention is evaluated as acceptable when satisfying the formula 2, as good when satisfying the formula 2a, and as excellent when satisfying the formula 2b. For the balance between toughness and the stiffness retention shown in Table 1, a molded article that does not satisfy the formula 2 is evaluated as “C,” and a molded article that satisfies the formula 2 but not the formula 2a is evaluated as “B,” and a molded article that satisfies the formula 2a but not the formula 2b is evaluated as “A,” and a molded article that satisfies the formula 2b is evaluated as “S”.

K≥−0.03×R+3.4 (Formula 2)

K≥−0.03×R+3.8 (Formula 2a)

K≥−0.03×R+4.0 (Formula 2b)

(K represents the toughness (MPa·m^{0.5}), and R represents the stiffness retention (%).)

### Example 1

An epoxy resin composition was prepared in the same manner as described above according to the number of parts (parts by mass) specified in the composition column in Table 1. A resulting molded article had a sufficiently high absorbance ratio, and the balance between Tg and rubbery modulus was acceptable as demonstrated by satisfaction of the formula 1, and the balance between toughness and stiffness retention was acceptable as demonstrated by satisfaction of the formula 2, which resulted from the presence of microdomains attributed to an elastomeric toughening agent.

### Example 2

The component [c] was changed from that used in Example 1 to a MAM block copolymer. The microdomains reduced the size to 0.04 μm, and the balance between toughness and stiffness retention consequently became good, satisfying the formula 2a.

### Example 3

The component [d] and the component [c] were changed from those used in Example 1 to a Broensted acid-base complex and a core shell rubber particle, respectively. The microdomains reduced the size to 0.1 μm, and the balance between toughness and stiffness retention consequently became good, satisfying the formula 2a.

### Example 4

The amount of the component [b] was decreased as compared to that in Example 3, so that the H/E ratio became 0.8. The balance between Tg and rubbery modulus was slightly deteriorated, and consequently the balance between toughness and stiffness retention was also slightly deteriorated but was still acceptable.

### Example 5

The amount of the component [b] was increased as compared to that in Example 3, so that the H/E ratio became 1.2. The balance between Tg and rubbery modulus was improved, and consequently the balance between toughness and stiffness retention was also improved and was excellent.

### Example 6

The amount of the component [b] was increased as compared to that in Example 3, so that the H/E ratio became 1.5. The balance between Tg and rubbery modulus was improved, and consequently the balance between toughness and stiffness retention was also improved and was excellent.

### Example 7

The amount of the component [b] was increased as compared to that in Example 3, so that the H/E ratio became 1.7. The balance between Tg and rubbery modulus was maintained at a good level, and consequently the balance between toughness and stiffness retention was also maintained at a good level.

### Example 8

The amount of the component [b] was increased as compared to that in Example 3, so that the H/E ratio became 1.9. The balance between Tg and rubbery modulus was slightly deteriorated, and consequently the balance between toughness and stiffness retention was also slightly deteriorated but was still acceptable.

### Example 9

The amount of the component [c] of Example 5 was decreased to 0.2% by mass. The toughness was reduced, but the balance between toughness and stiffness retention was acceptable as demonstrated by satisfaction of the formula 2.

### Example 10

The amount of the component [c] of Example 5 was increased to 4.0% by mass. The toughness was increased, and the balance between toughness and stiffness retention was good as demonstrated by satisfaction of the formula 2b.

### Example 11

In the composition of Example 5, an amine-type epoxy and the epoxy were used together as the component [a], and the component [b] was changed to a bifunctional curing agent, and the amount of the component [c] was increased to 7.7% by mass. The stiffness retention was reduced, but the balance between toughness and stiffness retention was acceptable as demonstrated by satisfaction of the formula 2.

### Example 12

Chlorophenyl isocyanate was added to the components of Example 3 as a component [e]. The balance between Tg and rubbery modulus was further improved, and consequently the balance between toughness and stiffness retention was good as demonstrated by satisfaction of the formula 2b.

### Example 13

The component [e] was changed from that used in Example 12 to sulfonyl isocyanate. The balance between toughness and stiffness retention was good as demonstrated by satisfaction of the formula 2b.

### Example 14

The component [e] was changed from that used in Example 12 to an acid anhydride. The balance between toughness and stiffness retention was good as demonstrated by satisfaction of the formula 2b.

### Comparative Example 1

An amine curing agent was added in place of the component [b]. The balance between Tg and rubbery modulus became unacceptable, and consequently the balance between toughness and stiffness retention was also unacceptable.

### Comparative Example 2

The component [c] was excluded from the composition of Example 3. The toughness was greatly reduced, and consequently the balance between toughness and stiffness retention became unacceptable.

### Comparative Example 3

The component [c] was excluded from the composition of Example 13. The toughness was greatly reduced, and consequently the balance between toughness and stiffness retention became unacceptable.

### Comparative Example 4

The amount of the component [b] was decreased as compared to that in Example 3, so that the H/E ratio became 0.6. The balance between Tg and rubbery modulus was deteriorated, and consequently the balance between toughness and stiffness retention became unacceptable.

### Comparative Example 5

The amount of the component [b] was increased as compared to that in Example 3, so that the H/E ratio became 2.1. The balance between Tg and rubbery modulus was slightly deteriorated, and consequently the balance between toughness and stiffness retention became unacceptable.

### Comparative Example 6

The component [d] was excluded from the composition of Example 3, and a strong base catalyst was added as a substitute. The toughness was reduced, and consequently the balance between toughness and stiffness retention became unacceptable.

### Comparative Example 7

The composition of the component [a] in Example 3 was altered. Furthermore, the component [d] was excluded from the composition of Example 3, and a Lewis acid-base complex catalyst was added as a substitute. The toughness was reduced, and consequently the balance between toughness and stiffness retention became unacceptable.

TABLE 1-1

| | | | | | | | | | | | | Ex. | Ex. |
|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | 10 | 11 |
| Composition | [a] | “Epotohto” YD-8125 | 100 | 100 | 94.6 | 95.1 | 94.2 | 93.4 | 93.0 | 92.5 | 99.4 | 88.0 | 21.5 |
| | Epoxy | “KANE ACE” MX-154 | | | 5.4 | 5.0 | 5.9 | 6.6 | 7.1 | 7.5 | 0.6 | 12.0 | 28.5 |
| | resin | epoxy component | | | | | | | | | | | |
| | | “ARALDITE” MY721 | | | | | | | | | | | 50 |
| | [b] | “Lupranate” M20S | 78 | 78 | 78 | 62 | 93 | 116 | 131 | 147 | 93 | 93 | |
| | Isocyanate | “Lupranate” MI | | | | | | | | | | | 110 |
| | curing agent | | | | | | | | | | | | |
| | [c] | “Nanostrength” E20F | 3.6 | | | | | | | | | | |
| | Elastomeric | “Nanostrength” M22N | | 3.6 | | | | | | | | | |
| | toughening | “KANE ACE” MX-154 | | | 3.6 | 3.3 | 3.9 | 4.4 | 4.7 | 5.0 | 0.4 | 8.0 | 19 |
| | agent | main component | | | | | | | | | | | |
| | [d] | Tetrabutylammonium | 1 | 1 | | | | | | | | | |
| | Oxazolidone | bromide | | | | | | | | | | | |
| | cyclization | TBD/dichloroacetic | | | 1 | 1 | 1 | 1 | 1 | 1 | 1 | 1 | 1 |
| | catalyst | acid | | | | | | | | | | | |
| | [e] | Chlorophenyl | | | | | | | | | | | |
| | Hydroxyl | isocyanate | | | | | | | | | | | |
| | group | Toluenesulfonyl | | | | | | | | | | | |
| | capping | isocyanate | | | | | | | | | | | |
| | agent | Chloroacetic anhydride | | | | | | | | | | | |
| | Others than | “Lonzacure” M-DEA | | | | | | | | | | | |
| | [a] | “DBU” | | | | | | | | | | | |
| | to [e] | Imidazolium salt | | | | | | | | | | | |

| | | | | | | | | | | | | |
|---|---|---|---|---|---|---|---|---|---|---|---|---|
| Properties | Amount of a combined [c] in each resin | 2.0 | 2.0 | 2.0 | 2.0 | 2.0 | 2.0 | 2.0 | 2.0 | 0.2 | 4.0 | 7.7 |
| of each | composition [% by mass] | | | | | | | | | | | |
| resin | Stoichiometric ratio of | 1.0 | 1.0 | 1.0 | 0.8 | 1.2 | 1.5 | 1.7 | 1.9 | 1.2 | 1.2 | 1.2 |
| composition | [b] to [a], H/E | | | | | | | | | | | |

TABLE 1-2

| | | | Ex. | Ex. | Ex. | Comp. | Comp. | Comp. | Comp. | Comp. | Comp. | Comp. |
|---|---|---|---|---|---|---|---|---|---|---|---|---|
| | | | 12 | 13 | 14 | Ex. 1 | Ex. 2 | Ex. 3 | Ex. 4 | Ex. 5 | Ex. 6 | Ex. 7 |
| Composi- | [a] | “Epotohto” | 94.6 | 94.6 | 94.6 | 93.7 | 100 | 100 | 94.6 | 94.6 | 100 | 100 |
| tion | Epoxy | YD-8125 | | | | | | | | | | |
| | resin | “KANE ACE” | 5.4 | 5.4 | 5.4 | 6.3 | | | 5.4 | 5.4 | | |
| | | MX-154 epoxy | | | | | | | | | | |
| | | component | | | | | | | | | | |
| | | “ARALDITE” MY721 | | | | 50 | | | | | | |
| | [b] | “Lupranate” M20S | 78 | 78 | 78 | | 78 | 78 | 46 | 163 | 78 | 78 |
| | Isocyanate | “Lupranate” MI | | | | | | | | | | |
| | curing | | | | | | | | | | | |
| | agent | | | | | | | | | | | |
| | [c] | “Nanostrength” E20F | | | | | | | | | | |
| | Elastomeric | “Nanostrength” M22N | | | | | | | | | | |
| | toughening | “KANE ACE” | 3.6 | 3.6 | 3.6 | 4.2 | | | 3.6 | 3.6 | 3.6 | 3.6 |
| | agent | MX-154 main | | | | | | | | | | |
| | | component | | | | | | | | | | |
| | [d] | Tetrabutylammonium | | | | | | | | | | |
| | Oxazolidone | bromide | | | | | | | | | | |
| | cyclization | TBD/dichloroacetic | 1 | 1 | 1 | | 1 | 1 | 1 | 1 | | |
| | catalyst | acid | | | | | | | | | | |
| | [e] | Chlorophenyl | 5 | | | | | | | | | |
| | Hydroxyl | isocyanate | | | | | | | | | | |
| | group | Toluenesulfonyl | | 5 | | | | 5 | | | | |
| | capping | isocyanate | | | | | | | | | | |
| | agent | Chloroacetic | | | 5 | | | | | | | |
| | | anhydride | | | | | | | | | | |
| | Others than | “Lonzacure” M-DEA | | | | 60 | | | | | | |
| | [a] | “DBU” | | | | | | | | | 1 | |
| | to [e] | Imidazolium salt | | | | | | | | | | 1 |

| | | | | | | | | | | | |
|---|---|---|---|---|---|---|---|---|---|---|---|
| Properties | Amount of a combined [c] in each | 2.0 | 2.0 | 2.0 | 2.0 | 0.0 | 0.0 | 2.0 | 2.0 | 2.0 | 2.0 |
| of each | resin composition [% by mass] | | | | | | | | | | |
| resin | Stoichiometric ratio of | 1.0 | 1.0 | 1.0 | — | 1.0 | 1.0 | 0.6 | 2.1 | 1.0 | 1.0 |
| composi- | [b] to [a], H/E | | | | | | | | | | |
| tion | | | | | | | | | | | |

TABLE 1-3

| | | | | | | | | | | | Ex. | Ex. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | 10 | 11 |
| Properties | Absorbance ratio | 0.7 | 0.7 | 0.7 | 0.7 | 0.7 | 0.7 | 0.6 | 0.55 | 0.7 | 0.7 | 0.7 |
| of each | Da/(Da + Db) | | | | | | | | | | | |
| molded | Glass transition | 175 | 178 | 177 | 170 | 182 | 186 | 184 | 179 | 183 | 180 | 193 |
| article | temperature | | | | | | | | | | | |
| | Tg [° C.] | | | | | | | | | | | |
| | Rubbery modulus | 3.7 | 3.3 | 3.5 | 3.2 | 3.8 | 4 | 4.2 | 4.3 | 3.9 | 3.7 | 5.1 |
| | Gr [MPa] | | | | | | | | | | | |
| | Glass transition | −50 | −40 | −50 | −50 | −50 | −50 | −50 | −50 | −50 | −50 | −50 |
| | temperature Tg′ of | | | | | | | | | | | |
| | microdomains | | | | | | | | | | | |
| | [° C.] | | | | | | | | | | | |
| | Volume fraction | 2 | 2 | 2 | 2 | 2 | 2 | 2 | 2 | 0.2 | 4 | 8 |
| | of microdomains | | | | | | | | | | | |
| | [% by volume] | | | | | | | | | | | |
| | Size of dispersed phases of | 3 | 0.04 | 0.1 | 0.1 | 0.1 | 0.1 | 0.1 | 0.1 | 0.1 | 0.1 | 0.1 |
| | microdomains [μm] | | | | | | | | | | | |
| | Dispersibility of | 0.8 | 0.4 | 0.6 | 0.6 | 0.6 | 0.6 | 0.6 | 0.6 | 0.6 | 0.6 | 0.6 |
| | microdomains | | | | | | | | | | | |
| Mechanical | Toughness | 1.2 | 1.4 | 1.5 | 1.3 | 1.7 | 1.6 | 1.5 | 1.3 | 1.1 | 1.9 | 1.5 |
| properties | [MPa · m^{0.5}] | | | | | | | | | | | |
| of each | Low-temperature | 1.45 | 1.52 | 1.50 | 1.49 | 1.51 | 1.50 | 1.46 | 1.44 | 1.48 | 1.44 | 1.45 |
| molded | stiffness | | | | | | | | | | | |
| article | (−50° C.) [GPa] | | | | | | | | | | | |
| | Normal-temperature stiffness | 1.24 | 1.33 | 1.32 | 1.29 | 1.36 | 1.37 | 1.39 | 1.34 | 1.41 | 1.20 | 1.12 |
| | (25° C.) [GPa] | | | | | | | | | | | |
| | High-temperature stiffness | 1.12 | 1.23 | 1.17 | 1.13 | 1.22 | 1.23 | 1.20 | 1.14 | 1.26 | 1.13 | 1.01 |
| | (120° C.) [GPa] | | | | | | | | | | | |
| | Stiffness retention (high- | 77 | 81 | 78 | 76 | 81 | 82 | 82 | 79 | 85 | 78 | 70 |
| | temperature/ | | | | | | | | | | | |
| | low-temperature) [%] | | | | | | | | | | | |
| | Balance between | B | A | A | B | S | S | A | B | B | S | B |
| | toughness and | | | | | | | | | | | |
| | stiffness retention | | | | | | | | | | | |

TABLE 1-4

| | | Ex. | Ex. | Ex. | Comp. | Comp. | Comp. | Comp. | Comp. | Comp. | Comp. |
|---|---|---|---|---|---|---|---|---|---|---|---|
| | | 12 | 13 | 14 | Ex. 1 | Ex. 2 | Ex. 3 | Ex. 4 | Ex. 5 | Ex. 6 | Ex. 7 |
| Properties | Absorbance ratio Da/(Da + Db) | 0.8 | 0.8 | 0.75 | — | 0.7 | 0.8 | 0.9 | 0.4 | 0.5 | 0.5 |
| of each | Glass transition | 175 | 175 | 173 | 172 | 184 | 177 | 155 | 175 | 176 | 162 |
| molded | temperature | | | | | | | | | | |
| article | Tg [° C.] | | | | | | | | | | |
| | Rubbery modulus Gr [MPa] | 3 | 3 | 3.2 | 8.6 | 4 | 3 | 3 | 5 | 5.9 | 4.1 |
| | Glass transition | −50 | −50 | −50 | −50 | — | — | −50 | −50 | −50 | −50 |
| | temperature Tg′ of | | | | | | | | | | |
| | microdomains [° C.] | | | | | | | | | | |
| | Volume fraction | 2 | 2 | 2 | 2 | — | — | 2 | 2 | 2 | 2 |
| | of microdomains | | | | | | | | | | |
| | [% by volume] | | | | | | | | | | |
| | Size of dispersed phases of | 0.1 | 0.1 | 0.1 | 0.1 | — | — | 0.1 | 0.1 | 0.1 | 0.1 |
| | microdomains [μm] | | | | | | | | | | |
| | Dispersibility of microdomains | 0.6 | 0.6 | 0.6 | 1.1 | — | — | 0.6 | 0.6 | 0.6 | 0.6 |
| Mechanical | Toughness | 2 | 2 | 1.7 | 0.8 | 0.7 | 0.9 | 1 | 1.5 | 1 | 1.1 |
| properties | [MPa · m^{0.5}] | | | | | | | | | | |
| of each | Low-temperature | 1.50 | 1.50 | 1.50 | 1.79 | 1.49 | 1.49 | 1.50 | 1.50 | 1.53 | 1.5 |
| molded | stiffness | | | | | | | | | | |
| article | (−50° C.) [GPa] | | | | | | | | | | |
| | Normal-temperature stiffness | 1.33 | 1.33 | 1.32 | 1.39 | 1.42 | 1.42 | 1.30 | 1.32 | 1.31 | 1.3 |
| | (25° C.) [GPa] | | | | | | | | | | |
| | High-temperature stiffness | 1.20 | 1.20 | 1.18 | 0.99 | 1.29 | 1.29 | 1.11 | 1.17 | 1.04 | 1.05 |
| | (120° C.) [GPa] | | | | | | | | | | |
| | Stiffness retention (high- | 80 | 80 | 79 | 55 | 87 | 87 | 74 | 78 | 68 | 70 |
| | temperature/ | | | | | | | | | | |
| | low-temperature) [%] | | | | | | | | | | |
| | Balance between toughness and | S | S | S | C | C | C | C | C | C | C |
| | stiffness retention | | | | | | | | | | |

Examples 15 to 20 and Comparative Examples 8 and 9 are as follows (including Table 2).

### (9) Production of Carbon Fibers

The carbon fibers [I] to [V] were produced according to the following production methods.

### <Carbon Fiber [I]>

A copolymer comprising 99.4% by mole of acrylonitrile and 0.6% by mole of methacrylic acid was used to produce acrylic precursor fibers with a single-fiber fineness of 0.08 tex and a filament count of 12000 by a dry-wet spinning method.

The precursor fibers were heated in the air at a temperature of 240° C. to 280° C. with applying a draw ratio of 1.05 to convert the precursor fibers to flameproofing fibers and were further heated in a nitrogen atmosphere at a rate of temperature increase of 200° C./min in the temperature range from 300° C. to 900° C. with applying a draw ratio of 1.10, and the temperature was then increased up to 1400° C. for calcination and promotion of carbonization. In the obtained carbon fibers, the linear density was 0.50 g/m, and the density was 1.80 g/cm³.

Subsequently, the carbon fibers were treated by electrolytic oxidation, in which an aqueous solution of ammonium bicarbonate at a concentration of 1.0 mol/L was used as an electrolyte and the quantity of electricity was 3 C/g·bath. After the electrolytic oxidation, the resulting carbon fibers were washed with water and then dried in air at 150° C. to obtain carbon fibers [I].

The carbon fibers [I] had a surface oxygen concentration O/C of 0.08, an average fiber diameter of 5.5 μm, and a substantially circular cross-section with a r/R ratio of 0.95.

### <Carbon Fiber [II]>

Carbon fibers [II] were produced and obtained under the same conditions as those for the carbon fibers [I], except that the quantity of electricity was altered to 30 C/g·bath for the electrolytic oxidation.

The carbon fibers [II] had a surface oxygen concentration O/C of 0.18, an average fiber diameter of 5.5 μm, and a substantially circular cross-section with a r/R ratio of 0.95.

### <Carbon Fiber [III]>

Carbon fibers [III] were produced and obtained under the same conditions as those for the carbon fibers [I], except that the quantity of electricity was altered to 1 C/g·bath for the electrolytic oxidation.

The carbon fibers [III] had a surface oxygen concentration O/C of 0.03, an average fiber diameter of 5.5 μm, and a substantially circular cross-section with a r/R ratio of 0.95.

### <Carbon Fiber [IV]>

Carbon fibers [IV] were produced and obtained under the same conditions as those for the carbon fibers [I], except that the quantity of electricity was altered to 100 C/g·bath for the electrolytic oxidation.

The carbon fibers [IV] had a surface oxygen concentration O/C of 0.22, an average fiber diameter of 5.5 μm, and a substantially circular cross-section with a r/R ratio of 0.95.

### <Carbon Fiber [V]>

Carbon fibers [V] were produced and obtained under the same conditions as those for the carbon fibers [I], except that the spinning method for the acrylic precursor fibers was replaced by a wet spinning method and the obtained acrylic precursor fibers had a single-fiber fineness of 0.09 tex. In the obtained reinforcing fibers, the linear density was 0.50 g/m, and the density was 1.80 g/cm³.

The carbon fibers [V] had a surface oxygen concentration O/C of 0.05, an average fiber diameter of 5.4 μm, and a flattened cross-section with a r/R ratio of 0.8.

### (10) Production of Carbon Fiber Woven Fabrics

The carbon fibers obtained through the above subsection (9) “Production of carbon fibers” were used as warps and wefts to produce plain carbon fiber woven fabrics with an areal weight of 190 g/m².

### (11) Preparation of Thermosetting Epoxy Resin Compositions

According to each of the compositions (in mass ratio) shown in Table 2, epoxy resin compositions were prepared in the same manner as in the above subsection (2) “Preparation of thermosetting epoxy resin compositions”.

### (12) Measurement of G_{1c}

From a carbon fiber woven fabric produced as described in the above subsection (10) “Production of carbon fiber woven fabrics,” 5 pieces of the woven fabric with a size of 400 mm×400 mm were cut in duplicate and laminated to prepare two sets of laminates, and the resulting two pairs of laminates were piled on the top of the other in a mold with a plate cavity. A film of “TOYOFLON (registered trademark)” E (manufactured by Toray Industries, Inc.) was sandwiched between the laminates, lying over an area 40 mm inside from the edges of the laminates and aligning along the direction of the fibers, and then compressed in the mold by a pressing machine. For this process, the thickness of the cavity was configured to allow each fiber-reinforced composite material to have a fiber volume content of 40%. Subsequently, a vacuum pump was used to reduce the pressure inside the mold to the atmospheric pressure −0.1 MPa, and a thermosetting epoxy resin composition prepared as described in the above subsection (11) “Preparation of thermosetting epoxy resin compositions” was injected with a pressure of 0.2 MPa into the mold by using a resin injector. Then, the thermoplastic epoxy resin composition was heated at a rate of 10° C./min from a normal temperature to 200° C., followed by immediate demolding to produce a fiber-reinforced composite material. The fiber-reinforced composite material was cut into a piece with a size of 20 mm in width and 200 mm in length, and aluminum blocks were attached to the edges of the piece of the composite material with the inserted film, aligning perpendicularly to the direction of the fibers, and a double cantilever beam test according to JIS K7086 (1993) was performed on the piece of the composite material by using a Instron universal tester. The test was performed at a crosshead speed of 1.0 mm/min to measure the fracture toughness. The fracture toughness was measured for 6 samples, and the average of the measured values was determined as G_{1c}.

### Example 15

A thermosetting epoxy resin was prepared as described in the above subsection (11) “Preparation of thermosetting epoxy resin compositions” and then used as described in the above subsection (12) “Measurement of G_{1c}” to form a fiber-reinforced composite material and to measure the G_{1c} of the fiber-reinforced composite material. The fiber-reinforced composite material had a G_{1c} of 450 J/m², which was excellent.

### Example 16

The component [c] was changed from that used in Example 15 to another species. The fiber-reinforced composite material had a G_{1c} of 440 J/m², which was excellent.

### Example 17

The composition of the component [a] in Example 15 was altered, and the component [c] was changed from that used in Example 15 to another species. The fiber-reinforced composite material had a G_{1c} of 460 J/m², which was excellent.

### Example 18

The reinforcing fiber in Example 17 was changed to another reinforcing fiber. The fiber-reinforced composite material had a G_{1c} of 600 J/m², which was particularly excellent.

### Example 19

The reinforcing fiber in Example 17 was changed to another reinforcing fiber. The fiber-reinforced composite material had a G_{1c} of 400 J/m², which was acceptable.

### Example 20

The reinforcing fiber in Example 17 was changed to another reinforcing fiber. The fiber-reinforced composite material had a G_{1c} of 650 J/m², which was particularly excellent.

### Example 21

The reinforcing fiber in Example 17 was changed to another reinforcing fiber. The fiber-reinforced composite material had a G_{1c} of 380 J/m², which was acceptable.

### Comparative Example 8

The component [c] was excluded from the composition of Example 15. The fiber-reinforced composite material had a G_{1c} of 300 J/m², which was poor.

### Comparative Example 9

The reinforcing fiber in Comparative Example 8 was changed to another reinforcing fiber. The fiber-reinforced composite material had a G_{1c} of 290 J/m², which was poor.

TABLE 2

| | | | Ex. | Ex. | Ex. | Ex. | Ex. | Ex. | Ex. | Comp. | Comp. |
|---|---|---|---|---|---|---|---|---|---|---|---|
| | | | 15 | 16 | 17 | 18 | 19 | 20 | 21 | Ex. 8 | Ex. 9 |
| Composi- | [a] Epoxy | “Epotohto” YD-8125 | 100 | 100 | 94.6 | 94.6 | 94.6 | 94.6 | 94.6 | 100 | 100 |
| tion | resin | “KANE ACE” MX-154 epoxy | | | 5.4 | 5.4 | 5.4 | 5.4 | 5.4 | | |
| | | component | | | | | | | | | |
| | | “ARALDITE” MY721 | | | | | | | | | |
| | [b] | “Lupranate” M20S | 78 | 78 | 78 | 78 | 78 | 78 | 78 | 78 | 78 |
| | Isocyanate | “Lupranate” MI | | | | | | | | | |
| | curing agent | | | | | | | | | | |
| | [c] | “Nanostrength” E20F | 3.6 | | | | | | | | |
| | Elastomeric | “Nanostrength” M22N | | 3.6 | | | | | | | |
| | toughening | “KANE ACE” MX-154 | | | 3.6 | 3.6 | 3.6 | 3.6 | 3.6 | | |
| | agent | main component | | | | | | | | | |
| | [d] | Tetrabutylammonium bromide | | | | | | | | | |
| | Oxazolidone | TBD/dichloroacetic | 1 | 1 | 1 | 1 | 1 | 1 | 1 | 1 | 1 |
| | cyclization catalyst | acid | | | | | | | | | |
| | Others than | “Lonzacure” M-DEA | | | | | | | | | |
| | [a] | “DBU” | | | | | | | | | |
| | to [e] | Imidazolium salt | | | | | | | | | |

| | | | | | | | | | |
|---|---|---|---|---|---|---|---|---|---|
| Carbon fiber | [I] | [I] | [I] | [II] | [III] | [IV] | [V] | [I] | [V] |
| G_{Ic} [J/m²] | 450 | 440 | 460 | 600 | 400 | 650 | 380 | 300 | 290 |
| Tensile strength [MPa] | — | — | — | — | — | — | — | — | — |

Examples 22 to 30 and Comparative Examples 10 and 11 are as follows (including Table 3).

### (13) Raw Materials for Thermosetting Epoxy Resin Compositions

Raw materials used to obtain thermosetting epoxy resin compositions of the examples are same as the raw materials for thermosetting epoxy resin compositions described in the above subsection (1).

### (14) Production of Glass Fibers

The glass fibers [I] to [VII] were produced according to the following production methods.

### <Glass Fiber [I]>

A glass fiber woven fabric KS2700 (manufactured by Nitto Boseki Co., Ltd.) was used.

### <Glass Fiber [II]>

A glass fiber woven fabric KS2700 (manufactured by Nitto Boseki Co., Ltd.) was immersed in a methanol solution (1% by mass) of a coupling agent KBM-403 (3-glycidoxypropyltrimethoxysilane, manufactured by Shin-Etsu Chemical Co., Ltd.) for 7 hours and then dried in a hot air oven at 110° C. for 5 hours to remove the solvent and provide glass fibers [II] having oxirane groups on the surface.

### <Glass Fiber [III]>

Glass fibers [III] having amino groups on the surface were produced under the same conditions as those for the glass fibers [II], except that KBM-903 (3-aminopropyltrimethoxysilane, manufactured by Shin-Etsu Chemical Co., Ltd.) was used as the coupling agent.

### <Glass Fiber [IV]>

Glass fibers [IV] having thiol groups on the surface were produced under the same conditions as those for the glass fibers [II], except that KBM-803 (3-mercaptopropyltrimethoxysilane, manufactured by Shin-Etsu Chemical Co., Ltd.) was used as the coupling agent.

### <Glass Fiber [V]>

Glass fibers [V] having carboxy groups on the surface were produced under the same conditions as those for the glass fibers [II], except that X-12-967C (3-(trimethoxysilyl)propylsuccinic anhydride, manufactured by Shin-Etsu Chemical Co., Ltd.) was used as the coupling agent.

### <Glass Fiber [VI]>

Glass fibers [VI] having vinyl groups on the surface were produced under the same conditions as those for the glass fibers [II], except that KBM-1003 (vinyltrimethoxysilane, manufactured by Shin-Etsu Chemical Co., Ltd.) was used as the coupling agent.

### <Glass Fiber [VII]>

Glass fibers [VII] having methyl groups on the surface were produced under the same conditions as those for the glass fibers [II], except that methyltrimethoxysilane (manufactured by Kanto Chemical Co., Inc.) was used as the coupling agent.

### (15) Preparation of Thermosetting Epoxy Resin Compositions

According to each of the compositions (in mass ratio) shown in Table 3, epoxy resin compositions were prepared in the same manner as in the above subsection (2) “Preparation of thermosetting epoxy resin compositions”.

### (16) Production of Glass Fiber Woven Fabrics

The glass fibers produced as described in the above subsection (14) “Production of glass fibers” were used as warps and wefts to produce plain glass fiber woven fabrics with an areal weight of 190 g/m².

### (17) Production of Fiber-Reinforced Composite Materials

From a glass fiber woven fabric produced as described in the above subsection (16) “Production of glass fiber woven fabrics,” 10 pieces of the woven fabric with a size of 400 mm×400 mm were cut and piled on one another in a mold with a plate cavity and then compressed in the mold by a pressing machine. For this process, the thickness of the cavity was configured to allow each fiber-reinforced composite material to have a fiber volume content of 40%. Subsequently, a vacuum pump was used to reduce the pressure inside the mold to the atmospheric pressure −0.1 MPa, and a thermosetting epoxy resin composition prepared as described in the above subsection (15) “Preparation of thermosetting epoxy resin compositions” was injected with a pressure of 0.2 MPa into the mold by using a resin injector. Then, the thermoplastic epoxy resin composition was heated at a rate of 10° C./min from a normal temperature to 200° C., followed by immediate demolding to produce a fiber-reinforced composite material.

### (18) Measurement of G_{1c}

From a glass fiber woven fabric produced as described in the above subsection (16) “Production of glass fiber woven fabrics,” 5 pieces of the woven fabric with a size of 400 mm×400 mm were cut in duplicate and laminated to prepare two sets of laminates, and the resulting two pairs of laminates were piled on the top of the other in a mold with a plate cavity. A film of “TOYOFLON (registered trademark)” E (manufactured by Toray Industries, Inc.) was sandwiched between the laminates, lying over an area 40 mm inside from the edges of the laminates and aligning along the direction of the fibers, and then compressed in the mold by a pressing machine. For this process, the thickness of the cavity was configured to allow each fiber-reinforced composite material to have a fiber volume content of 40%. Subsequently, a vacuum pump was used to reduce the pressure inside the mold to the atmospheric pressure −0.1 MPa, and a thermosetting epoxy resin composition prepared as described in the above subsection (15) “Preparation of thermosetting epoxy resin compositions” was injected with a pressure of 0.2 MPa into the mold by using a resin injector. Then, the thermoplastic epoxy resin composition was heated at a rate of 10° C./min from a normal temperature to 200° C., followed by immediate demolding to produce a fiber-reinforced composite material. The fiber-reinforced composite material was cut into a piece with a size of 20 mm in width and 200 mm in length, and aluminum blocks were attached to the edges of the piece of the composite material with the inserted film, aligning perpendicularly to the direction of the fibers, and a double cantilever beam test according to JIS K7086 (1993) was performed on the piece of the composite material by using a Instron universal tester. The test was performed at a crosshead speed of 1.0 mm/min to measure the fracture toughness. The fracture toughness was measured for 6 samples, and the average of the measured values was determined as G_{1c}.

### (19) Measurement of Tensile Strength

The fiber-reinforced composite materials produced as described in the above subsection (17) “Production of fiber-reinforced composite materials” were analyzed by performing the tensile test in accordance with JIS K 7164: 2005 to determine the tensile strength.

### Example 22

A thermosetting epoxy resin was prepared as described in the above subsection (15) “Preparation of thermosetting epoxy resin compositions” and then used as described in the above subsection (17) “Production of fiber-reinforced composite materials” to produce a fiber-reinforced composite material. Additionally, a fiber-reinforced composite material was formed and the G_{1c} of the fiber-reinforced composite material was measured, as described in the above subsection (18) “Measurement of G_{1c}”. The fiber-reinforced composite material had a G_{1c} of 750 J/m², which was excellent, and a tensile strength of 220 MPa, which was acceptable.

### Example 23

The component [c] was changed from that used in Example 22 to another species. The fiber-reinforced composite material had a G_{1c} of 740 J/m², which was excellent, and a tensile strength of 220 MPa, which was acceptable.

### Example 24

The component [a] and the component [c] were changed from those used in Example 22 to other species. The fiber-reinforced composite material had a G_{1c} of 760 J/m², which was excellent, and a tensile strength of 225 MPa, which was acceptable.

### Example 25

The reinforcing fiber in Example 24 was changed to another reinforcing fiber. The fiber-reinforced composite material had a G_{1c} of 700 J/m², which was excellent, and a tensile strength of 235 MPa, which was excellent.

### Example 26

The reinforcing fiber in Example 24 was changed to another reinforcing fiber. The fiber-reinforced composite material had a G_{1c} of 800 J/m², which was particularly excellent, and a tensile strength of 235 MPa, which was excellent.

### Example 27

The reinforcing fiber in Example 24 was changed to another reinforcing fiber. The fiber-reinforced composite material had a G_{1c} of 700 J/m², which was excellent, and a tensile strength of 235 MPa, which was excellent.

### Example 28

The reinforcing fiber in Example 24 was changed to another reinforcing fiber. The fiber-reinforced composite material had a G_{1c} of 650 J/m², which was excellent, and a tensile strength of 235 MPa, which was excellent.

### Example 29

The reinforcing fiber in Example 24 was changed to another reinforcing fiber. The fiber-reinforced composite material had a G_{1c} of 600 J/m², which was acceptable, and a tensile strength of 240 MPa, which was excellent.

### Example 30

The reinforcing fiber in Example 24 was changed to another reinforcing fiber. The fiber-reinforced composite material had a G_{1c} of 600 J/m², which was acceptable, and a tensile strength of 240 MPa, which was excellent.

### Comparative Example 10

The component [c] was excluded from the composition of Example 22. The fiber-reinforced composite material had a G_{1c} of 500 J/m², which was poor, and a tensile strength of 200 MPa, which was poor.

### Comparative Example 11

The reinforcing fiber in Comparative Example 10 was changed to another reinforcing fiber. The fiber-reinforced composite material had a G_{1c} of 460 J/m², which was poor, and a tensile strength of 190 MPa, which was poor.

TABLE 3

| | | | Ex. | Ex. | Ex. | Ex. | Ex. | Ex. | Ex. | Ex. | Ex. | Comp. | Comp. |
|---|---|---|---|---|---|---|---|---|---|---|---|---|---|
| | | | 22 | 23 | 24 | 25 | 26 | 27 | 28 | 29 | 30 | Ex. 10 | Ex. 11 |
| Composi- | [a] Epoxy | “Epotohto” YD-8125 | 100 | 100 | 94.6 | 94.6 | 94.6 | 94.6 | 94.6 | 94.6 | 94.6 | 100 | 100 |
| tion | resin | “KANE ACE” MX-154 | | | 5.4 | 5.4 | 5.4 | 5.4 | 5.4 | 5.4 | 5.4 | | |
| | | epoxy component | | | | | | | | | | | |
| | | “ARALDITE” MY721 | | | | | | | | | | | |
| | [b] | “Lupranate” M20S | 78 | 78 | 78 | 78 | 78 | 78 | 78 | 78 | 78 | 78 | 78 |
| | Isocyanate | “Lupranate” MI | | | | | | | | | | | |
| | curing agent | | | | | | | | | | | | |
| | [c] | “Nanostrength” E20F | 3.6 | | | | | | | | | | |
| | Elastomeric | “Nanostrength” M22N | | 3.6 | | | | | | | | | |
| | toughening | “KANE ACE” MX-154 | | | 3.6 | 3.6 | 3.6 | 3.6 | 3.6 | 3.6 | 3.6 | | |
| | agent | main component | | | | | | | | | | | |
| | [d] | Tetrabutylammonium | | | | | | | | | | | |
| | Oxazolidone | bromide | | | | | | | | | | | |
| | cyclization | TBD/dichloroacetic | 1 | 1 | 1 | 1 | 1 | 1 | 1 | 1 | 1 | 1 | 1 |
| | catalyst | acid | | | | | | | | | | | |
| | Others | “Lonzacure” M-DEA | | | | | | | | | | | |
| | than [a] to | “DBU” | | | | | | | | | | | |
| | [e] | Imidazolium salt | | | | | | | | | | | |

| | | | | | | | | | | | |
|---|---|---|---|---|---|---|---|---|---|---|---|
| Glass fiber | [I] | [I] | [I] | [II] | [III] | [IV] | [V] | [VI] | [VII] | [I] | [VII] |
| G_{Ic} [J/m²] | 750 | 740 | 760 | 700 | 800 | 700 | 650 | 600 | 600 | 500 | 460 |
| Tensile strength [MPa] | 220 | 220 | 225 | 235 | 235 | 235 | 235 | 240 | 240 | 200 | 190 |

### INDUSTRIAL APPLICABILITY

The thermosetting epoxy resin compositions of the invention can be used in a wide range of fields and applications, such as transportation and general industry, as molding materials capable of exhibiting stable performance in various environments because cured products of the thermosetting epoxy resin compositions have high toughness and can maintain high stiffness in a wide temperature range from low to high temperature. The thermosetting epoxy resin compositions make great contributions to, particularly, increase of production and improvement of performance of fiber-reinforced composite materials, which promotes application of fiber-reinforced composite materials to various industrial materials as well as to structural materials for automobiles or aircrafts, and are potentially expected to contribute to reduction of greenhouse gas emission due to the weight reduction of these materials and the resulting improvement of energy saving performance.

1. A thermosetting epoxy resin composition comprising the following components [a], [b], [c], and [d], wherein the stoichiometric ratio [b]/[a] of the component [b] to the component [a] is in the range from 0.7 to 2.0:
[a] an epoxy resin;
[b] an isocyanate curing agent;
[c] an elastomeric toughening agent;
[d] an oxazolidone cyclization catalyst.

2. The thermosetting epoxy resin composition according to claim 1, wherein the component [d] is at least one catalyst selected from the group consisting of a Broensted acid-base complex and an onium halide salt.

3. The thermosetting epoxy resin composition according to claim 1, wherein the component [c] is at least one elastomeric toughening agent selected from the group consisting of a block copolymer and a core shell rubber particle.

4. The thermosetting epoxy resin composition according to claim 1, wherein the content of the component [c] is not less than 0.2% by mass and not more than 8% by mass relative to the total amount of the thermosetting epoxy resin composition, which is taken as 100% by mass.

5. The thermosetting epoxy resin composition according to claim 1, further comprising the component [e] and satisfying the following condition (1):
[e] a hydroxyl group capping agent;
(1) the peak temperature Te of the exothermic reaction between the component [e] and a hydroxyl group is 15° C. or more lower than the peak temperature Tb of the exothermic reaction between the component [b] and a hydroxyl group
(Te is the peak temperature of the exothermic curve obtained by differential scanning calorimetry performed at a rate of temperature increase of 10° C./min on a mixture of 1-phenoxy-2-propanol and the component [e] in a mass ratio of 10:1; Tb is the peak temperature of the exothermic curve obtained by differential scanning calorimetry performed at a rate of temperature increase of 10° C./min on a mixture of 1-phenoxy-2-propanol and the component [b] in a mass ratio of 10:1).

6. The thermosetting epoxy resin composition according to claim 1, wherein the component [e] comprises at least one compound selected from the group consisting of the following compounds [I] to [III]:
[I] a compound that contains at least one isocyanate group in the molecule;
[II] a compound that contains at least one carbodiimide group in the molecule;
[III] a compound that contains at least one acid anhydride structure in the molecule.

7. The thermosetting epoxy resin composition according to claim 1, wherein the component [e] comprises a compound that contains at least one isocyanate group in the molecule.

8. A thermosetting epoxy resin-based molded article prepared by thermally curing the thermosetting epoxy resin composition according to claim 1.

9. The thermosetting epoxy resin-based molded article according to claim 8, comprising microdomains with an absorbance ratio Da/(Da+db) ranging from 0.55 to 1 and a glass transition temperature Tg′ of −30° C. or lower
(the absorbance ratio is determined by calculating an absorbance ratio Da/(Da+db) from the absorbance Da of the C═O double bond in the carboxyl group of an oxazolidone ring and the absorbance db of the C═O double bond in the carboxyl group of an isocyanurate ring measured by the FT-IR/ATR method).

10. The thermosetting epoxy resin-based molded article according to claim 8, in which the relationship between the glass transition temperature Tg and the rubbery modulus Gr expressed by the formula 1 is satisfied, and which comprises microdomains with a glass transition temperature Tg′ of −30° C. or lower:
Tg≥10×Gr+130 (Formula 1).

11. A thermosetting epoxy resin-based molded article comprising microdomains with an absorbance ratio Da/(Da+db) ranging from 0.55 to 1 and a glass transition temperature Tg′ of −30° C. or lower
(the absorbance ratio is determined by calculating an absorbance ratio Da/(Da+db) from the absorbance Da of the C═O double bond in the carboxyl group of an oxazolidone ring and the absorbance db of the C═O double bond in the carboxyl group of an isocyanurate ring measured by the FT-IR/ATR method).

12. A thermosetting epoxy resin-based molded article, in which the relationship between the glass transition temperature Tg and the rubbery modulus Gr expressed by the formula 1 is satisfied, and which comprises microdomains with a glass transition temperature Tg′ of −30° C. or lower:
Tg≥10×Gr+130 (Formula 1).

13. The thermosetting epoxy resin-based molded article according to claim 8, wherein the rubbery modulus Gr is in the range from 0.5 MPa to 15 MPa.

14. The thermosetting epoxy resin-based molded article according to claim 9, wherein the volume fraction of the microdomains is from 0.2% to 8% by volume.

15. The thermosetting epoxy resin-based molded article according to claim 9, wherein the microdomains are dispersed phases with a size of 0.01 to 30 micrometers.

16. The thermosetting epoxy resin-based molded article according to claim 9, wherein the microdomains have a dispersion of not more than 1.0.

17. A molding material for fiber-reinforced composite material comprising the thermosetting epoxy resin composition according to claim 1 and a reinforcing fiber.

18.-22. (canceled)

23. A fiber-reinforced composite material prepared by thermally curing the molding material for fiber-reinforced composite material according to claim 17.

24. (canceled)

25. A method of producing a fiber-reinforced composite material, comprising placing a woven fabric composed primarily of reinforcing fibers into a mold, injecting the thermosetting epoxy resin composition according to claim 1 into the mold for impregnation, and then curing the thermosetting epoxy resin composition by heat.

26.-30. (canceled)

31. A fiber-reinforced composite material comprising the thermosetting epoxy resin-based molded article according to claim 8 and a reinforcing fiber.

32.-36. (canceled)
